(19) United States
(12) Patent Application Publication
(10) Pub. No.: US 2005/0210001 A1
(43) Pub. Date: Sep. 22, 2005

(54) FIELD SEARCHING METHOD AND SYSTEM HAVING USER-INTERFACE FOR COMPOSITE SEARCH QUERIES

(76) Inventor: YEUN-JONQ LEE, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,738

(22) Filed: Mar. 22, 2004

(51) Int. Cl. G06F 17/30

(52) U.S. Cl. 707/3

(57) ABSTRACT

A method first sets and combines searching conditions, and second, displays search results and saves searching conditions. When setting searching conditions, the method allows a user to select data fields and appropriate comparison operators, and input searching values to form single searching conditions. After one or more single searching conditions are input, the method displays those single searching conditions, and then combines the single searching conditions to form a composite searching condition. Composite searching conditions can further be combined with other searching conditions. When the combination process reaches a desired searching condition, the method retrieves matching information and displays search results. The final searching condition can be saved in a search system for the convenience of future use.

### BACKGROUND OF INVENTION

1. Field of the Invention

he present invention relates to an improved field searching method and system having a user-interface for composite search queries. More specifically, the present invention provides a user-interface used on an electronic device with a CPU for inputting searching conditions that can be combined further to form composite searching conditions, which represent the precise information queries and can be processed to retrieve information.

2. Description of the Prior Art

Information searching is one of the most important technologies in the information industry. The more data stored in information systems, the more demand to improve the methods for finding the right information in a few seconds. What is important is no longer the quantity but the quality of the information that people can find. There are various and abundant information on the Internet or information systems, making it more difficult to discover the data or information that is just exactly what he or she wants. Therefore, search systems have become a foundational function in websites or computer-based information systems such as enterprise application systems. As the quantity and complexity of information has been increasing at an unprecedented speed, personalized information search services will be the trend to evolve. By the assistance of information search function, these provides appropriate searching directions adapted to users requests and interests to get the more precise information and, at the same time, to increase user satisfaction.

Search systems usually combine” searching subjects” and “searching values” to form “searching conditions”, which are commands to process search queries. “Searching subjects” represent the data fields that are the targets to be found such as author, title, or publishing date, etc. “Searching values” represent the desired information values of the corresponding searching subjects. To set up the searching conditions needs different comparison operators and logic operators. A single subject (data field) needs comparison operators such as “>”, “<”, or “=” to form a searching condition. Combining identical or different subjects (data fields) to form a searching condition needs the assistance of logic operators such as “AND”, “OR”, or “NOT”. We define a “single searching condition” as a searching condition that includes only one “searching subject (data field)”, “comparison operator(“>”, “<”, or “=” etc.)”, and “searching value”. For example, “Author=Robert C. Faber”. We also define a “composite searching condition” as a searching condition that is combined by any two or more “single searching conditions” and logic operators (“AND”, “OR”, etc.). For example, “Author=Stephen Blank AND Title=the Crisis of Global Capitalism” or “Author=Stephen Blank OR Author=Robert C. Faber OR Title=the Crisis of Global Capitalism”. A “composite searching condition” can further be combined with “single searching conditions” or another” composite searching conditions” to form a more complex “composite searching condition”.

The following is an example to demonstrate the combination of “composite searching conditions”. Three “single searching conditions”: (A) Gender=female; (B) Age>20; (C) Education=university can be connected by logic operators such as “AND”, or “OR”. There will be eight different ways to compose these three single searching conditions producing different searching results:

(A AND B) AND C, [which equals (A AND B AND C)]

(A OR B) OR C, [which equals (A OR B OR C)]

(A AND B) OR C,

(B AND C) OR A,

(C AND A) OR B,

(A OR B) AND C,

(B OR C) AND A, AND

(C OR A) AND B.

Taking “(B OR C) AND A” as an example, the meaning of this searching condition is “(Age>20 OR Education=university) AND Gender=female”. This searching condition is composed by two single searching conditions with a logic operator “OR” first and another single searching condition “Gender=female” with a logic operator “AND”. Those who are female with age more than 20 or those who are female with education degree equal to university will match the searching condition.

However, if we use the searching condition described above “(Age>20 OR Education=university) AND Gender =female” to do the search work in the conventional search systems, they will force the searching conditions with logic operator “AND” to be searched in advance. The searching condition will become “(Gender=female AND Age>20) OR Education=university”, which is not the same with the previous searching request. The searching result will include those who are “male” with education degree equal to university!

By using the search systems broadly applied in the websites or enterprise application systems, users can only input restricted searching conditions provided by those search systems. They cannot arbitrarily use the comparison operators (such as >, <, or = etc.) or logic operators (such as AND, OR etc.) to form the searching conditions that they exactly demand. In FIG. 1, flowcharts of search systems for the prior art, two conventional processes in the information search operations are shown. Those prior technologies partly or totally restrict the searchable data fields and the logical operations of searching subjects. Users cannot input searching conditions according to their exact requests. The following describes three search systems of the prior art in order to illustrate the deficiencies of conventional searching technologies.

(1)Search System Type 1:

As shown in FIG. 2, the expanded search system of HOLLIS CATALOG in Harvard Libraries website (http://128.103.60.91/), a search function to select keywords from data fields such as “Author words”, “Title words”, etc are provided. And different searching fields are connected by logic operators such as “AND”, “OR”, or “NOT”. For example, users can input the searching condition of “Author words including Mundell AND Title words including economics OR Title words including monetary”. This kind of system only provides three or limited field search boxes and one constant comparison operator (including) to process the search. Users cannot add a fourth or more fields for searching. This conventional search system can further limit a search according to the types of language, locations, format or the year range. For example, users can select “Language=English OR French” in the “Language” field, “Locations=Afro-American Studies OR Andover-Harv. Theol” in the “Locations” field, “Format =Books” in the “Format” field, and “Year Range>=1990 and Year Range <=1999” in the “Year Range” field. This part of the search functions, though it provides various fields and comparison operators to further limit the search range, still restricts users to search according to those limited and fixed fields and logic operations. For example, users cannot set the searching condition of “Language =French OR Year Range from 1990˜1999” at the same time. Moreover, as shown in FIG. 3, there are 607 hits of the searching condition “Author words including Smith AND Title words including environment OR Title words including ecosystem”. Actually the user wanted to find publications in which author names include “Smith” and in which title words include “environment” or “ecosystem” (the searching condition is “Author words including smith AND (Title words including environment OR Title words including ecosystem)”). However, the conventional search system retrieves publications in which title words include “ecosystem” or the publications in which author names include “Smith” and in which title words include “environment”, which is not the same as the initial search request. Consequently, the conventional search system still substantially restricts search fields and searching conditions. The searching hits are not precise and most are excluded after one by one review.

(2) Search System Type 2:

Another kind of search system of the prior art provides a more flexible query set up by allowing typing of a search statement into a query text entry box. Shown in FIG. 4 is the advanced search function provided in the USPTO Patent Full-Text and Image Database (http://patft.uspto.gov/netahtml/search-adv.htm). The search system will retrieve information according to selected years and a search statement. In the search statement, users must type the field codes to narrow the search to hits occurring within the specific fields. Users also can mix field searching with logic operators such as “AND”, “OR”, or “ANDNOT”. Moreover, parentheses can be added in to further clarify the search statement. For example, the search statement can be formed as “(ttl/nasal OR ttl/nose) AND an/MCNC”, meaning that patents which titles include “nasal” or “nose” and which assignee names include “MCNC” will be found. This kind of search system really provides a lot of flexibility to do the search process. However, users need to understand the meaning and format of each field code in order to type correctly the query that includes corresponding fields. Further, users need to transform the query to a line of words that contain the searching fields, searching values, and the logic operators in sequence with proper format. For example, a user wants to search for patents which titles includes “(LCD OR liquid crystal display) AND method”, which inventor country is “Japan OR Korea OR U.S.”, and which application dates are “Nov. 1, 1999˜May 12, 2002”. First the user must find out each field code of “title”, “inventor country” and “application date”, and second, type the search statement in the text entry box. The search statement is “(ttl/LCD OR ttl/liquid crystal display) AND ttl/method AND (icn/Japan or icn/Koera OR icn/U.S.) AND apd/ Nov. 1, 1999˜May 12, 2002”. As the length of the search statement gets longer, it becomes inconvenient for a general user to enter the search statement in sequence because he or she must learn the right field codes and format and type the search statement without logical or format errors. Applying this better search system in the more complex databases such as enterprise application systems that may contains thousands of data fields, users must check each field code and format first and then combine them with proper logical operators. The process is so time-consuming that users would rather use the easier but restricted search method to get rough but abundant results first and than check them one by one to find out which really match the desired query. Besides, the search system only provides a constant comparison operator of “including”, it cannot search the query according to other comparison operators such as “>”, “<” for numbers, or “beginning with a certain string” for strings.

(3)Search System Type 3:

Conventional database system such as MICROSOFT “ACCESS” provide the function of “Search Table” for technical users to search for information. Before users can apply the function, they must have technical knowledge of databases. Moreover, they need to understand and memorize where the searching fields in the searching condition saved in the corresponding tables and fields in the database are. After those preparations, they can begin to use the function of “Search Table” to generate demanded searching conditions. Therefore, information technology experts who do not understand the data structure, the relations between each table and the connections between the searching subjects and data fields cannot use the conventional technology of “Search Table” to generate the demanded searching conditions. Thus, general users who do not only have any technical knowledge of databases and also know nothing about the data structure and data relations likely cannot use the conventional technology of “Search Table” to generate the demanded searching conditions.

We use an example searching condition “(male AND single AND birthday>Jan. 1, 1960) OR (female AND single AND birthday>Jan. 1, 1970)” to illustrate the above statement. Shown in FIG. 5 is a “Search Table” in ACCESS. Firstly, users need to choose which tables to show, which means that users need to understand which tables are related to the searching condition, and to memorize the table names to correctly select the right tables related to the searching conditions.

Secondly, in FIG. 6, users need to understand and memorize the correspondent field names in the database. For example, the correspondent field name of “Gender” is “Gender_mf”, and the correspondent field name of “Marital status” is “Marriage_yn”, etc. The table illustrated is used for setting the searching conditions. The different fields in the same row are connected by the logic operator “AND”, and the searching conditions in the different rows are connected by the logic operator “OR”. To set up the searching condition, users must correctly select the corresponding field names, and input the appropriate searching values. Therefore, using the function of “Search Table” in the conventional system of ACCESS, users need to have database knowledge in advance, and understand and memorize the data structure and names of tables and data fields to set up the correct searching conditions.

There are hundreds of tables and thousands of data fields in a typical applied database. If general users want to use the function of “Search Table” in the conventional system to set up demanded searching conditions, they need to be trained about the database knowledge and understand the data structure in advance to execute the action of setting searching conditions. Therefore, non-technical users cannot use the conventional technology to set up the demanded searching conditions.

If we want to use the function of “Search Table” to set up a complicated searching condition, we need to decompose the searching conditions first, and then we can start the set up of searching condition. As shown in the example searching condition “((male AND single AND birthday >Jan. 1, 1960) OR (female AND single AND birthday >Jan. 1, 1970)) AND (education=university OR education =master)”, because the logic relation between two searching conditions in the conventional system is only “OR”, we should decompose the partial searching condition “AND (education=university OR education=master)” from the previous searching condition. The decomposed searching condition becomes “(male AND single AND birthday>Jan. 1, 1960 AND education=university) OR (male AND single AND birthday>Jan. 1, 1960 AND education =master) OR (female AND single AND birthday >Jan. 1, 1970 AND education=university) OR (female AND single AND birthday>Jan. 1, 1970 AND education=master)”. Shown in FIG. 7, we can only input this format of searching condition in the “Search Table” of the conventional system to execute the search.

Users need to check the correspondent table names and field names, and they still need to decompose the searching conditions. That will cause the situation that the users need to repeatedly input the same search conditions. For example, the partial search condition “(male AND single AND birthday>Jan. 1, 1960)” will need to be inputted twice. Thus, the function of “Search Table” in the conventional system is inconvenient and difficult.

If the searching conditions are more complicated, it is more difficult for general users to set up the searching conditions in the “Searching Table” of the conventional system. For example, the searching condition “((male AND single AND birthday>Jan. 1, 1970) OR (female AND single AND birthday>Jan. 1, 1970)) AND ((education=university OR education=master) OR (living in Taipei AND (blood type=O OR blood type=A)))”, the users need to decompose the searching condition into “(male AND single AND birthday>Jan. 1, 1960 AND education=university) OR (female AND single AND birthday>Jan. 1, 1970 AND education =university) OR (male AND single AND birthday >Jan. 1, 1960 AND education=master) OR (female AND single AND birthday>Jan. 1, 1970 AND education=master) OR (male AND single AND birthday>Jan. 1, 1960 AND living in Taipei AND blood type=A) OR (male AND single AND birthday>Jan. 1, 1960 AND living in Taipei AND blood type=O) OR (female AND single AND Birthday>Jan. 1, 1970 AND living in Taipei AND blood type=A) OR (female AND single AND Birthday>Jan. 1, 1970 AND living in Taipei AND blood type=O)”. Then the user can input this format of searching conditions in the “Search Table” of the conventional system, as shown in FIG. 8.

Users need to repeatedly input the similar partial searching conditions in the in the “Search Table”. For example, the partial searching condition “(male AND single AND birthday>Jan. 1, 1960)” has to be inputted four times. In another way, users need to decompose the original searching condition into a fixed searching structure “(. . . AND . . . AND. . . ) OR (. . . AND . . . AND . . . ) OR . . . ”, meaning that the logic operator “OR” combines searching conditions which are combined by the logic operator “AND”. This has limited ways for user to input the searching conditions. When the searching condition becomes more complicated, the amount of decomposed searching conditions will increase hugely. No doubt it will increase the difficulty for general users to decompose the searching condition. Hence, it becomes even more inconvenient for users to input the searching condition. Therefore, the “Search Table” in the conventional system needs the users to have the database knowledge and understand the data structure and correspondent tables and data fields. Moreover, users are required to decompose the original search conditions. These difficulties make it troublesome for general users to use the “Search Table” of the conventional system to generate demanded searching conditions.

Database systems, such as enterprise application systems, usually provide a specific programing language for search queries. If the conventional search interface cannot execute composite search queries, users must enter the internal database to write programing language instructions for the specific search query. However, before using this kind of conventional search method to input the search queries correctly, users need to first learn the language of search queries. They also need to understand the data structure, the interrelations between different data fields and the field name and format of each data field. It is hard for general users to learn such technical knowledge; therefore, they have to depend on skilled information engineers to search out the desired information. They cannot do the composite search work independently and the time to get the search results also increases. Even for skilled information engineers, this conventional search method is not convenient and is difficult to use. Different database software provide different tools and languages to execute search commands. Additionally, there are thousands of data fields in a typical database; it is not easy to memorize each field name, data type, and their interrelations. The names of data fields may be “TD10001”, “TD10002”, etc. Accordingly, they need to check the index table to search the correspondent field names. Further, a different or nonstandard search request requires another command written in a search query language, which is not convenient nor automatic. Because this conventional method is too technical to apply, general users cannot benefit from it.

Accordingly, there is a need to facilitate and speed up the presentation and selection of composite search queries. This, in turn, will substantially increase the commercial value and practicability of search systems.

### SUMMARY OF INVENTION

An object of the present invention is to provide a system used on an electronic device for searching for information by setting the combinations of searching conditions and logical operators. That is, to provide a search system with unrestricted searching conditions and flexible combinations of logical operators to simplify the information search processes.

Another object of the invention is to store searching conditions on the search system to provide for future similar searches. Users need not repeatedly set the searching conditions for the specific information that is frequently searched for.

The technical characteristic of the present invention allows general users to use the present invention to select multiple data fields and to set up searching conditions according to their demands in order to reach more precise information searches. According to the searching requests, the present invention can combine all kinds of data fields freely to process one search command. The present invention also provides different comparison operators according to different formats of data fields. Moreover, if the search needs to combine two or more searching conditions, the invention provides all kinds of combinations of those different data fields. Parentheses “( )” can be arbitrarily added in two or more searching conditions. This allows users to spend less time or a fewer number of searches to find the demanded information. Moreover, when the connecting relation between searching conditions becomes more complicated, users need not decompose the original searching condition, in contrast, users only need to combine the searching conditions to generate the final searching condition.

In the present invention, users need not have any technical knowledge of databases and need not understand and memorize data fields and tables corresponding to searching subjects. Users only select and set up the searching condition according to the demanded searching request. Thus, the present invention is more adaptive and convenient for general non-technical users.

To accomplish the objects above, a method used on an electronic device for information search is disclosed. It comprises two parts, firstly setting searching conditions and combining the searching conditions and secondly displaying the searching results and saving the conditions. In the step of setting searching conditions, the process includes choosing the data fields, appropriate comparison operators and comparison operators, and then inputting the searching values to form single searching conditions. After inputting one or more than one single searching conditions, the system will display those single searching conditions (including data fields, comparison operators, and searching values). Then, combining the single searching conditions to form a composite searching conditions as a new searching condition is performed. Moreover, the composite searching conditions can further be combined with other searching conditions. There is no limit to the number of times of combination. Logic operators are freely used. When the combination reaches the final searching condition, the present invention will retrieve matched information and display the searching results. The final searching condition can be saved on the search system for the convenience of future use.

These and other objects of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flowchart of information search processes in the conventional search systems.

FIGS. 2-3 illustrate one of the conventional search systems, the expanded search system of HOLLIS CATALOG in Harvard Libraries website.

FIG. 4 illustrates another kind of conventional search system, the advanced search function provided in the USPTO Patent Full-Text and Image Database.

FIGS. 5-8 illustrate another kind of conventional search system, the function of “Search Table” provided by ACCESS.

FIG. 9 is a flowchart of information search processes in the present invention.

FIG. 10 shows a simplified representation of a preferred overall implementation of the invention in a computer network in accordance with the preferred embodiment.

FIGSS. 11-16 illustrate the steps to generate a searching condition “(male and single and birthday>Jan. 1, 1960) OR (female AND single AND birthday>Jan. 1, 1970)” in accordance with an embodiment of the present invention.

FIGS. 17-20 illustrate the steps to generate a searching condition “((male AND single AND birthday>Jan. 1, 1960) OR (female AND single AND birthday>Jan. 1, 1970) AND (education=university OR education=master)” in accordance with an embodiment of the present invention.

FIGS. 21-26 illustrate the steps to generate a searching condition “((male AND single AND birthday>Jan. 1, 1960) OR (female AND single AND birthday>Jan. 1, 1970) AND ((education=university OR education=master) OR (living in Taipei AND (blood type=O OR blood type=A)))“in accordance with an embodiment of the present invention.

FIG. 27 shows a computerized “Sales Order” processing form in accordance with an embodiment of the present invention.

FIG. 28, shows the user interface of the search system displaying all the data fields related to the computerized “Sales Order” processing form in accordance with an embodiment of the present invention.

FIG. 29, shows the comparison operators of data type “number” in accordance with an embodiment of the present invention.

FIG. 30, shows the comparison operators of data type “date” in accordance with an embodiment of the present invention.

FIG. 31, shows the comparison operators of data type “string” in accordance with an embodiment of the present invention.

FIG. 32, shows the comparison operators of data type “selection list” in accordance with an embodiment of the present invention.

FIGS. 33-35 illustrate the steps of generating a searching condition “((Sales area=Taipei Or Sales area=Shinchu) And Sales date in 90 days And Total Sales amount>10,000 And Sale status ≠Cancel)” in accordance with an embodiment of the present invention.

FIG. 36 shows the form for inputting a saving name for saved searching conditions in accordance with an embodiment of the present invention.

FIGS. 37-38 illustrate the function of exporting searching results in accordance with an embodiment of the present invention.

FIG. 39 illustrates executing the function of frequent search in accordance with an embodiment of the present invention.

FIG. 40 illustrates the characteristic of the least search time in accordance with an embodiment of the present invention.

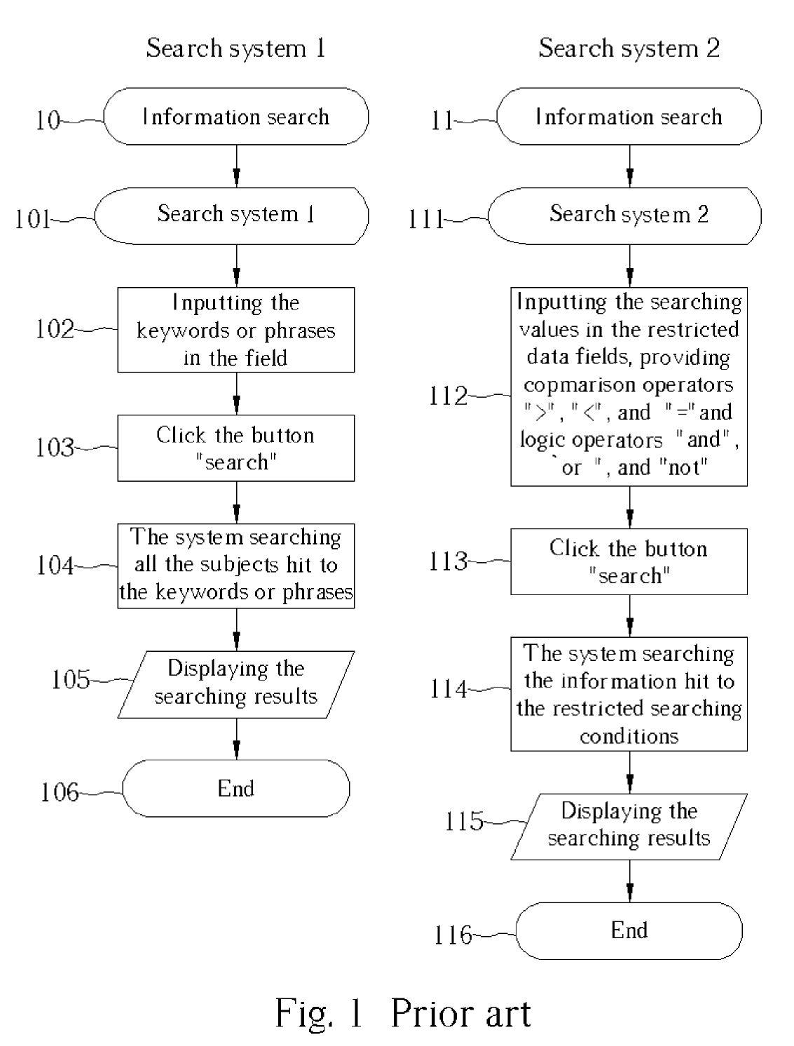

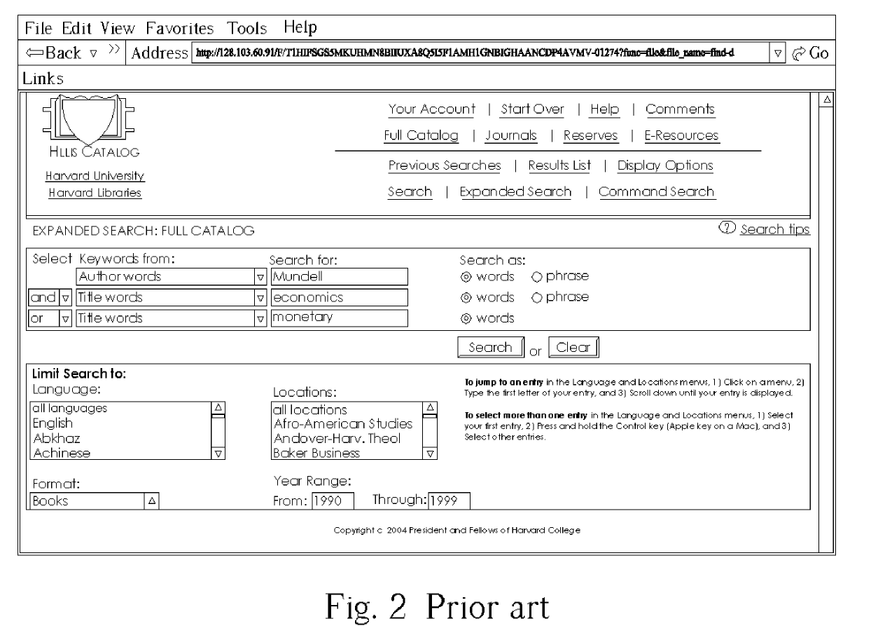

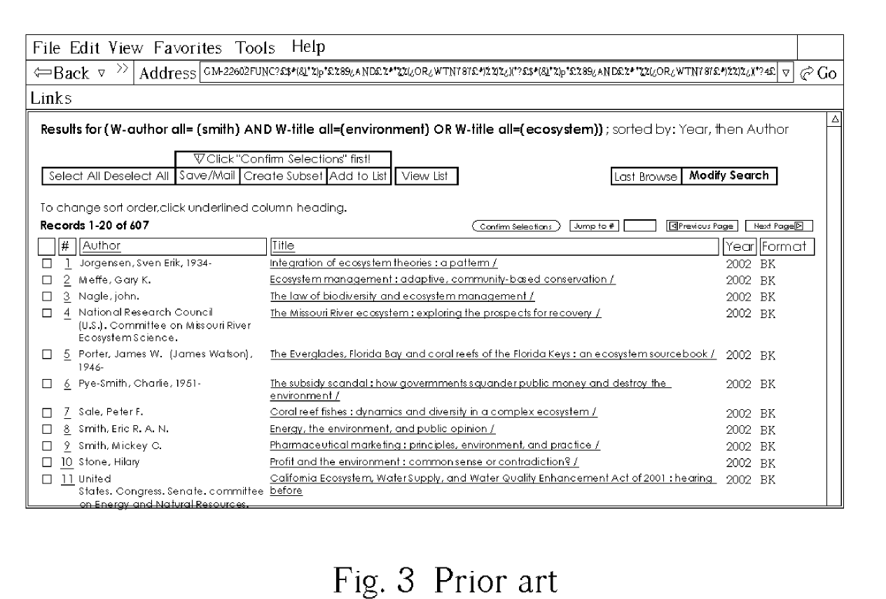

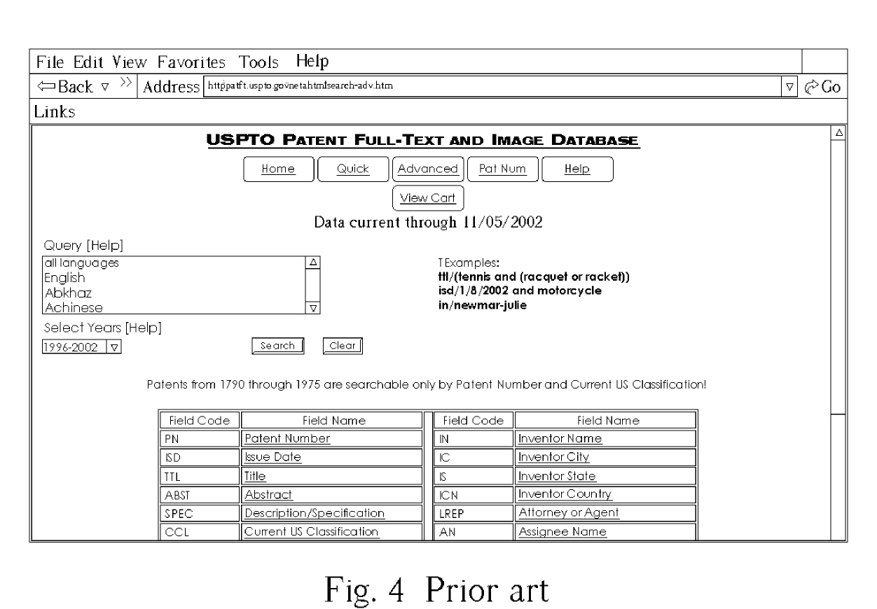

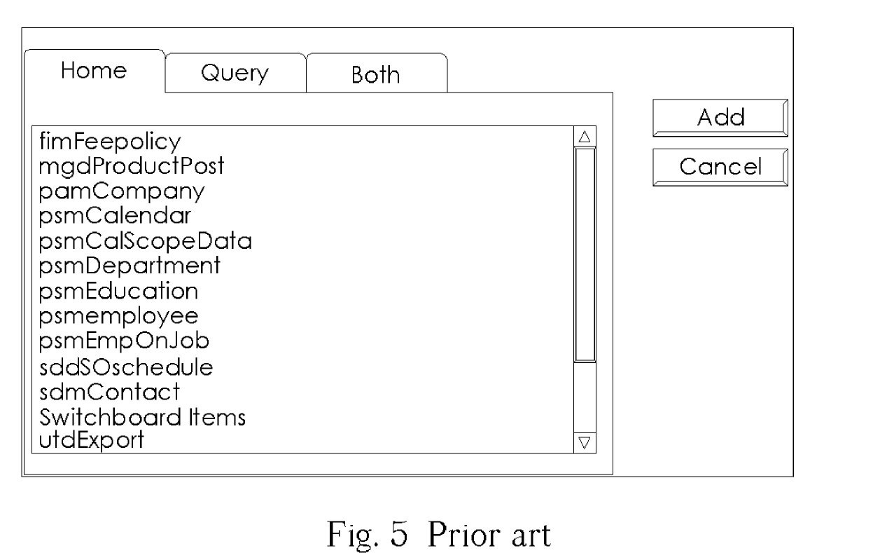

### DETAILED DESCRIPTION

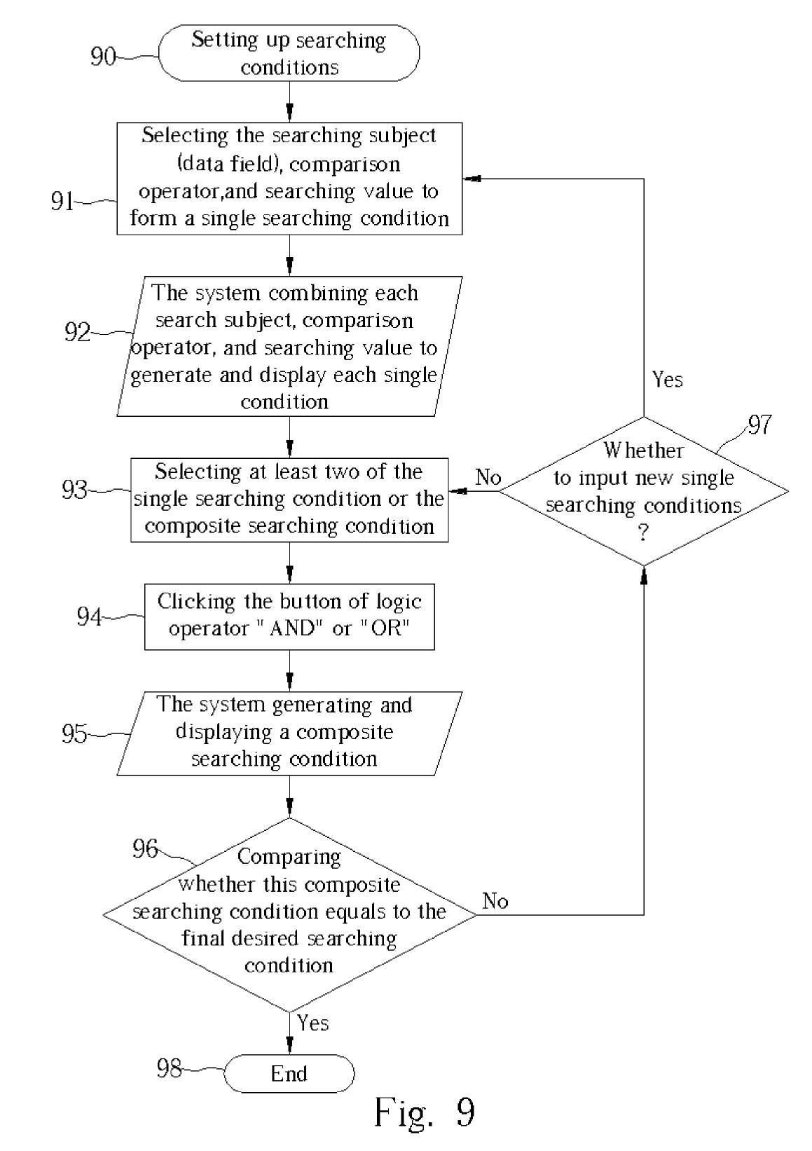

FIG. 9 is the flowchart of the method of information search in accordance with an embodiment of the present invention. The main purpose is to set up searching conditions, step 90, according to the desired search query. The first step is enabling a user to select the searching subject (data field), comparison operator, and searching value to form a single searching condition, step 91. This step can be repeated to input other single searching conditions.

Secondly, after the user finishes setting up each single searching condition, the system will automatically combine each searching subject, comparison operator, and searching value to generate and display each single searching condition, step 92. Based on the desired search query, the third step is enabling the user to select at least two searching conditions, step 93, and select a logic operator “AND” or “OR” by clicking a button, step 94. The system will combine those selected searching conditions and selected logic operators to generate and display a composite searching condition, step 95, which is defined by parentheses “()” accordingly.

The fourth step is comparing whether this composite searching condition equals the final desired searching condition, step 96. If it equals the final desired searching condition, searching conditions setup will end, step 98. If the final desired searching condition has not yet been generated, then the method allows choosing whether to input new single searching conditions, step 97.

At step 97, if the user does not input new single searching conditions, then the method returns to step 93 (selecting at least two searching conditions, so that single or composite searching conditions can be selected), and then allows clicking the button “AND” or “OR”, step 94. The system will combine the selected searching conditions and logic operator to generate and display a new composite searching condition, step 95. Then, the step 96 comparison is repeated.

At step 97, if the user needs to input new single conditions, then the method returns to step 91 (inputting new single searching conditions), and the system will combine the searching subject, comparison operator, and searching value to generate and display each searching condition, and then executes steps 93, 94, and 95 (selecting searching conditions and combining searching conditions). Then, the step 96 comparison is repeated.

The method is repeated until a final desired searching condition is generated, after which the method of searching conditions setup ends, step 98.

Regarding steps 91-97, the order of performing the steps can be different from that described above provided that the effect is similar. In addition, the steps 91-97 need not be contiguous; another step or other steps can be inserted between the steps 91-97.

Enabling the user to select the searching subject (data field) means that the system will automatically read the data fields saved in the database and display each caption of data field for the user to select. The method of displaying captions of the data fields can be a drop down menu or displaying them in another window. User need not to know the names of data fields saved in the tables in the database. Oppositely, users can directly select the desired searching subjects (data fields) according to captions of data fields that are easily identifiable. For example, the system will automatically display the captions of data fields such as “Supplier number”, “Total sales amount”, etc. Users need not type or check the index table to input the names of data fields, such as “TM0003”, “Sop_num”, or “TM0019”, “Sal_amt”, etc.

The system displaying each caption of each data field for the users to select means that the system will read the names, captions, data types of the data fields from a computerized processing form and display the caption of data fields.

The computerized processing form is a computerized functional form containing and allocating different data fields. For example, the computerized processing form contains data fields such as “S/O number”, “customer name”, “sales item”, “price”, “quantity”, etc.

The system reads a computerized processing form in the following three ways:

1. If one computerized processing form only saves and reads the correlative tables and son tables in the database, the present search system will only read and display all the data fields in the correlative tables and son tables contained in the computerized processing form. In other words, as the computer starts a computerized processing form and starts the search system of the present invention, the search system will read all the data fields in the tables contained in the computerized processing form as the selection of searching subjects. When starting a different computerized processing form, the system will read different data fields in the different tables contained in the different computerized processing form. For example, in a computerized processing form for inputting a sales order, users can start the present search system to search the data fields related to the sales order. And in a computerized processing form for inputting a purchase order, users can start the present search system to search the data fields related to the purchase order.

2. If one computerized processing form saves and reads a plurality of different types of tables and son tables in the database, the present search system will read and display all the data fields in those tables and son tables contained in this computerized processing form. For example, in a computerized processing form for sales and payment, when starting the search system of present invention, the present invention will display all the data fields in those correlative tables contained in this computerized processing form for users to select. Users need not to know about the data structure in the database or the interrelation between those tables. Users just select from those displayed data fields to generate different single searching conditions and combine them to form the final desired searching condition.

3. If one computerized processing form saves and reads a plurality of tables and son tables in a plurality of different databases, the present search system will read and display all the data fields in those tables and son tables contained in this computerized processing form. Users can search information in different databases at the same time. For example, if users want to search the sales information in company A and company B, they only need to select the searching subjects displayed in the search system of the present invention. Users need not to know that the data of company A and company B are saved in different databases, nor the data structure and interrelation of each database. The search system of the present invention will display all the correlative captions of data fields about sales of company A and B.

Taking an enterprise resources planning system as an example, different levels of management usually need to apply different levels of search ranges. In the computerized processing form of managing delivery operations, the search system will read and display the data fields limited to those about delivery operations such as “delivery warehouse” or “quantity of return” for search. If a manager wants to search the matches of sales and inventory, the search system will read and display the searching subject including data fields about sales and inventory. If a vice president wants to search the sales conditions in all subcompanies, the search system will read and display the searching subjects across different databases. In other words, the search system of the present invention provides different ranges of data fields for searching subjects according to different search levels or requests. Users need not understand or learn the structures of databases, programming languages, or interrelations among data fields. They only need to select what they want to search.

The search system will also read the data type of each data field. If the data type is “number”, it provides comparison operators “=”, “≠”, “>”, “<”, “ [symbol] ”, and“ [symbol] ”. If the data type is “date”, it provides comparison operators “=”, “≠”, “>”, “<”, “ [symbol] ”,“ [symbol] “, ” in ? days”, and “before ? days”. If the data type is “string”, it provides comparison operators “=”, “≠”, “including”, “beginning with”, and “ending with”. If the data type is “Boolean” (yes or no) or “selection format” (the system providing a plurality of items of searching value), it provides comparison operators “=” and “≠”.The search system of the present invention will determine the data type according to inputted searching subjects (data fields) and display the comparison operators of this kind of data type automatically.

The system will also decide the data types of inputted data fields and display different input formats in the input fields. If the data type is “number”, “string”, or “date” with comparison operator selected as “in ? days” or “before ? days”, the system will display a space for a inputting searching value which will be restricted to a number or string data type. If the data type is “date” excluding comparison operator selected as “in ? days” or “before ? days”, the system will display a date format, such as “/ / ”, for inputting a searching value of date. If the data type is “Boolean” or “selection format”, the system will read its item lists and display these in the field of searching value. For example, if the data field selected is “the lowest quantity limited?”, it will display “yes” and “no” as the field of searching value for selection. If the data field selected is “currency”, it will display items such as “U.S. Dollar”, “Yen”, and “Euro” for selection.

The method of generating single searching conditions increases the flexibility and convenience for users to set up desired searching conditions. Users can generate single searching conditions without limitation on the quantity of searching conditions. Additionally, the system will automatically read and display the captions of data fields for selecting as searching subjects. The system will decide its different data type and display appropriate and various comparison operators, letting users to set exact desired searching conditions. The present invention improves the limitations in the quantity of searching conditions and comparison operators in the conventional search systems.

The system accepts selected searching conditions and logic operators to combine them and displays a composite searching condition. The searching conditions that have been selected will still be displayed and can be selected continuously to combine into another composite searching condition. Composite searching conditions are combined from at least two single searching conditions, at least two composite searching conditions, or at least one single searching condition and at least one composite searching condition with a logic operator “AND” or “OR”. Whenever combining a composite searching condition, the system will automatically include parentheses “( )” to represent the priorities of searching commands.

Using the search method provided by the present invention can accurately generate the final desired searching condition. Users need not learn or understand the data structure of databases, field names, data types, and interrealtions among data fields in advance. Users just selected desired searching subjects in the displayed selection list of captions of data fields. The system will automatically decide the data type of the selected data field and display appropriate comparison operators and inputted format of searching value to set up unlimited searching conditions. Moreover, these searching conditions can be combined by logic operators “AND” and “OR” in order to construct a final desired searching condition. Users need not memorize field names, or the rules for inputting searching conditions. Users also need not type manually, instead they can use a pointing device such as a mouse to make selections. Therefore, the present invention increases the accuracy of searches and makes it a lot easier to generate composite searching conditions.

Further, users can click the button “delete” to delete a single or composite searching condition that has been generated. After generating the final searching condition, users can click the button “preview”. The system will transform the final searching condition to a search command programming language and execute it to retrieve and display the searching results. Moreover, the final searching condition can be saved for the future use. Next time, if the desired searching condition is the same or similar, the user can enter the search system of the present invention to execute directly the saved searching condition and to retrieve the update information of the searching conditions. Users need not input searching conditions repeatedly.

After the system displays searching results, it further provides a function of exporting the searching results to other file such as MICROSOFT EXCEL. Moreover, users can select the data fields to export and group. If the exported data are countable (such as price or quantity), the system will sum the amount of each group and the total amount and display the searching results after organizing.

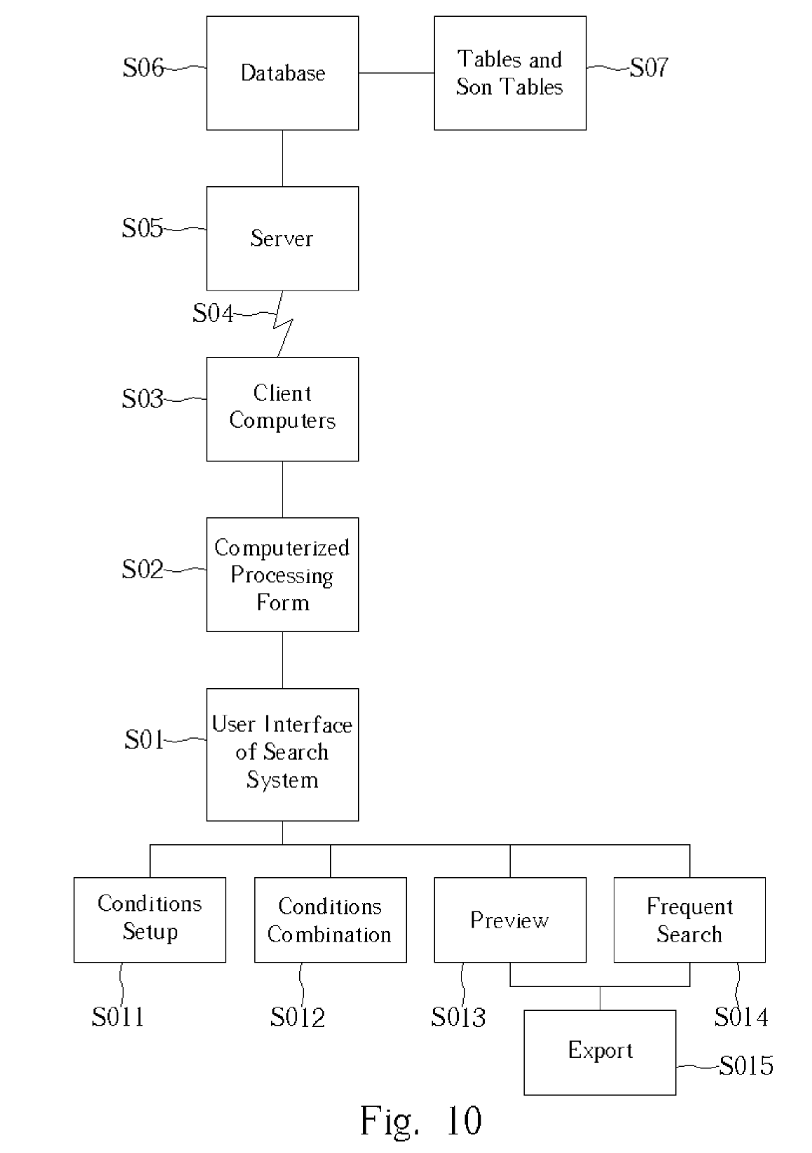

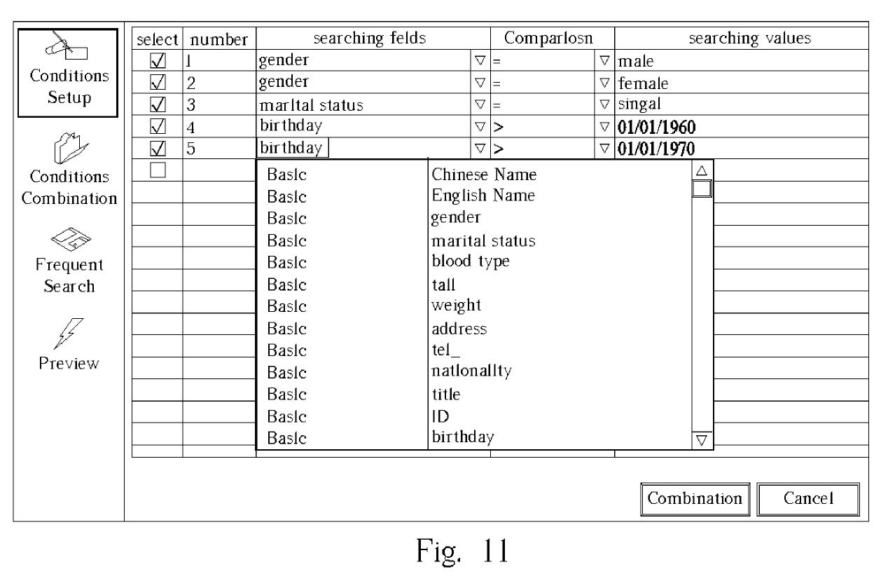

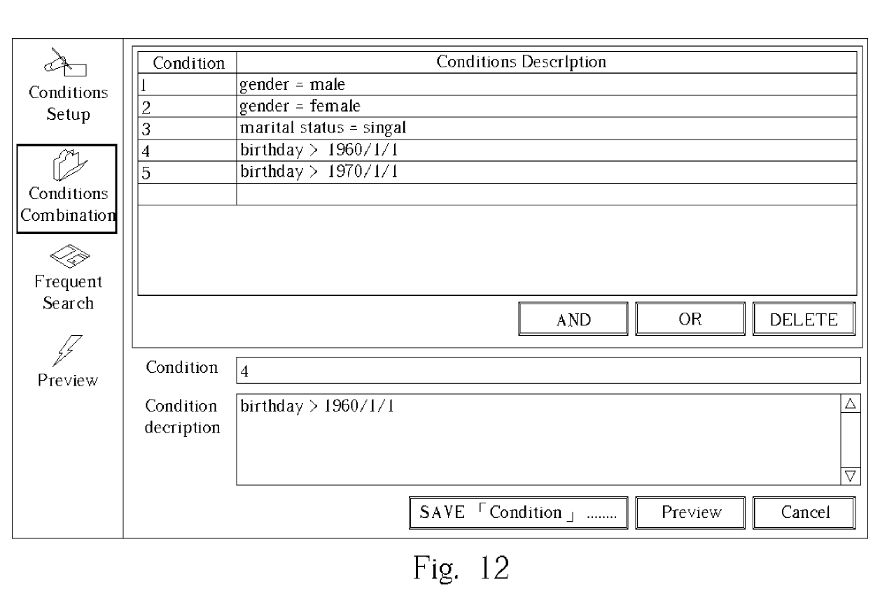

FIG. 10 shows a simplified representation of a preferred overall implementation of the invention in a computer network in accordance with a preferred embodiment. A plurality of client computers S03 are networked to a remotely located server S05 by a bi-directional communication link S04. Client computers S03 contain, at a minimum, memory, a CPU, and computerized processing form S02, which can call a user interface of search system S01 to retrieve information. The server S05 contains, at a minimum, memory, a CPU, and a database for storing information. The database contains table(s) and son table(s) to save different types of information. The data fields saved and read in the computerized processing form are from the same type of tables and son tables S07 in one database S06, or from different type of tables and son tables in one database, or from different databases. The user interface of the search system S01 contains the functions of Conditions Setup S011 to set up single searching conditions, Conditions Combination S012 to combine searching conditions and logic operators to composite searching conditions, Preview S013 to display the searching results, Frequent Search S014 to display saved searching conditions, and Export S015 to export searching results. A programming language can also be embedded in the user interface of the search system to execute search functions.

In the computerized processing form S02 the user interface of the search system S01 is called, and the system will read the data fields contained in the computerized processing form S02 and display them in the searching field Conditions Setup S011 by a drop down menu or another window for selection. It also displays appropriate comparison operators according to different data types to set up single searching conditions. The function Conditions Combination S012 allows the user to combine searching conditions and logic operators to generate a final desired searching condition. According to the final desired searching condition, the system will go to relative tables to retrieve information and display it in the Preview S013. Users can save this final desired searching condition. Next time for the same or similar search request, in the function Frequent Search S014, users can select the searching condition directly to retrieve the updated information. The searching results can be further exported via the Export S015 function to another file such as EXCEL for further management.

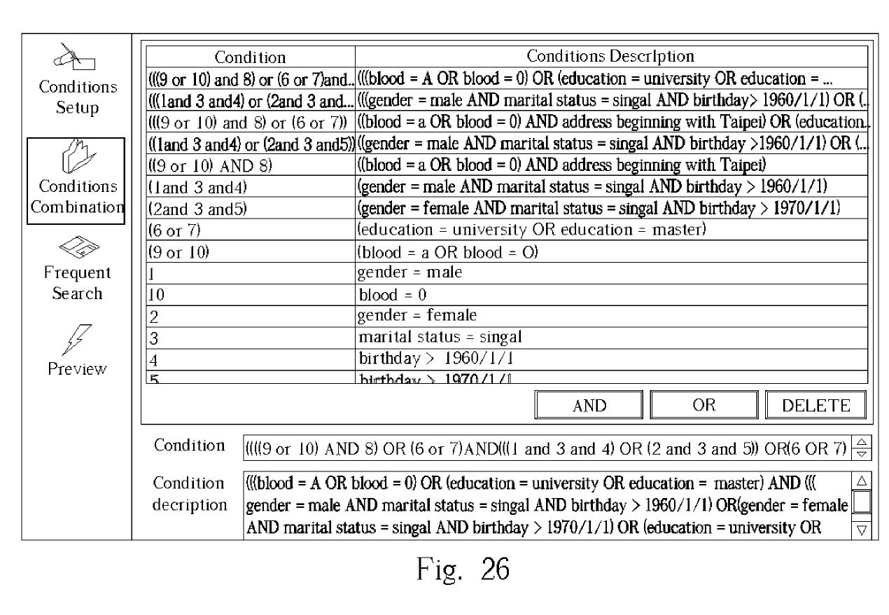

An embodiment of present invention as described above is discussed in the following examples and in FIG. 11˜FIG. 26.

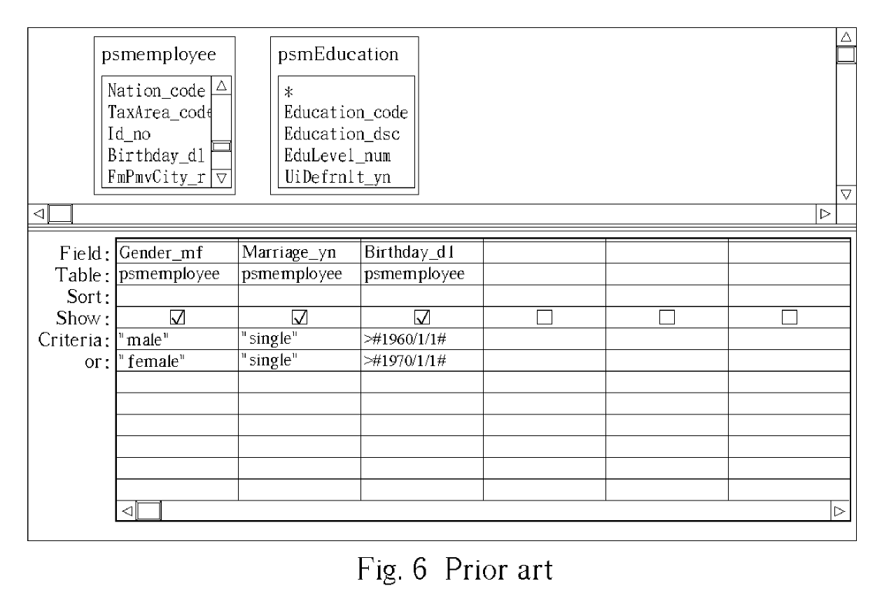

Suppose that a company is going to hold a small party and needs to find employees who fit in with the following conditions: single male employees born after Jan. 1, 1960 and single female employees born after Jan. 1, 1970. Those employees who match the above conditions can join the party. The searching condition statement is “(male AND single AND birthday>Jan. 1, 1960) OR (female AND single AND birthday>Jan. 1, 1970)”, which is the same with the previous example in FIG. 6 for the comparison purpose.

After deciding the conditions, a user enters the human management system and clicks the button “search”. The system will display the “search system-conditions setup”.

Using the present invention, as shown in FIG. 11, the user can set up the conditions to find the employees who can join the party. First, the user inputs the searching conditions according to the employees qualifications.

Condition 1: the searching subject is “gender”, comparison condition is “=”, and the searching value is “male”;

Condition 2: the searching subject is “gender”, comparison condition is “=”, and the searching value is “female”;

Condition 3: the searching subject is “marital status”, comparison condition is “=”, and the searching value is “single”;

Condition 4: the searching subject is “birthday”, comparison condition is “>”, and the searching value is “Jan. 1, 1960”;

Condition 5: the searching subject is “birthday”, comparison condition is “>”, and the searching value is “Jan. 1, 1970”.

After finishing the searching conditions setup, the user clicks the button “combination”. As shown in FIG. 12, the system will switch to “search system-conditions combination”. The table will show those five single searching conditions constructed by searching subjects, comparison conditions, and searching values. The user chooses conditions “1”, “3”, and “4”, then clicks the button “AND”. The system will display the partial searching condition “(male AND single AND birthday>Jan. 1, 1960)”, as shown in FIG. 13. The user then chooses conditions “2”, “3”, and “5”, then clicks the button “AND”. The system will display the partial condition “(female AND single AND birthday>Jan. 1, 1970)”, as shown in FIG. 14. The user chooses condition “(1 AND 3 AND 4)” and “(2 AND 3 AND 5)”, then clicks the button “OR”. The system will display the final searching condition “(male and single and birthday>Jan. 1, 1960) OR (female AND single AND birthday>Jan. 1, 1970)”, as shown in FIG. 15.

Comparing the difference between FIG. 6 in the conventional system and FIG. 15 of the present invention, the present invention shows more directly the searching condition combined by users. Anyone can combine the demand searching condition directly. They do not need to have database knowledge or understand the data structure in advance.

The user can press the button “Preview”, and the system will start to execute the searching command and display the searching results, as shown in FIG. 16. The user can adopt the searching result by clicking the button “Adopt” or leave the system by clicking the button “Delete”.

Moreover, the user can click the button “Save Condition” to save the searching conditions, input the file name and press the button “OK”. Next time a user can simply choose the condition name directly and to perform another search. The saved searching conditions can also be deleted, previewed, adopted, or forgone.

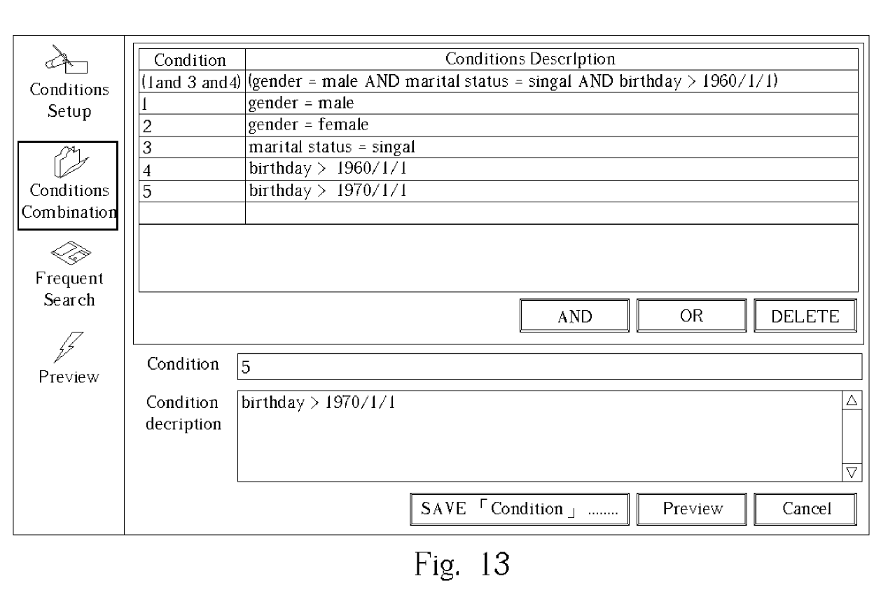

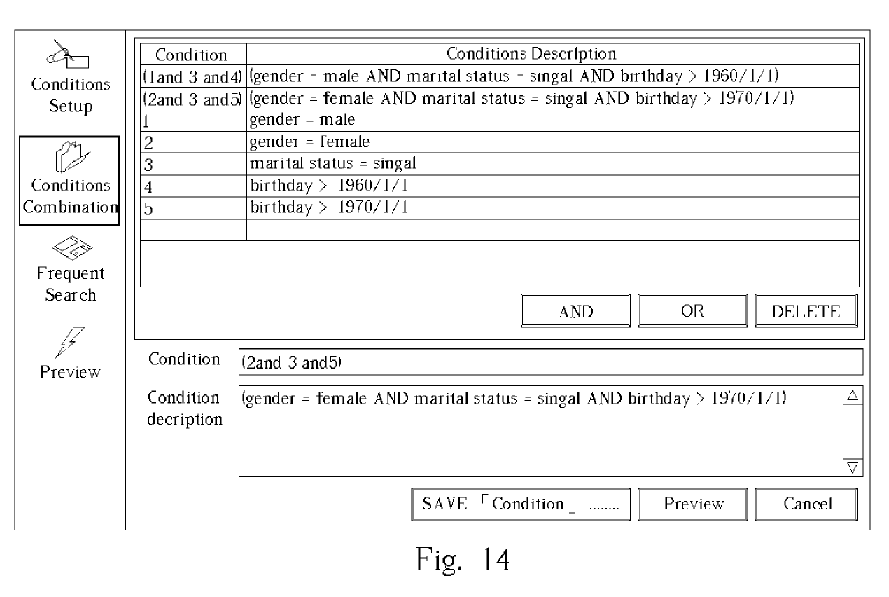

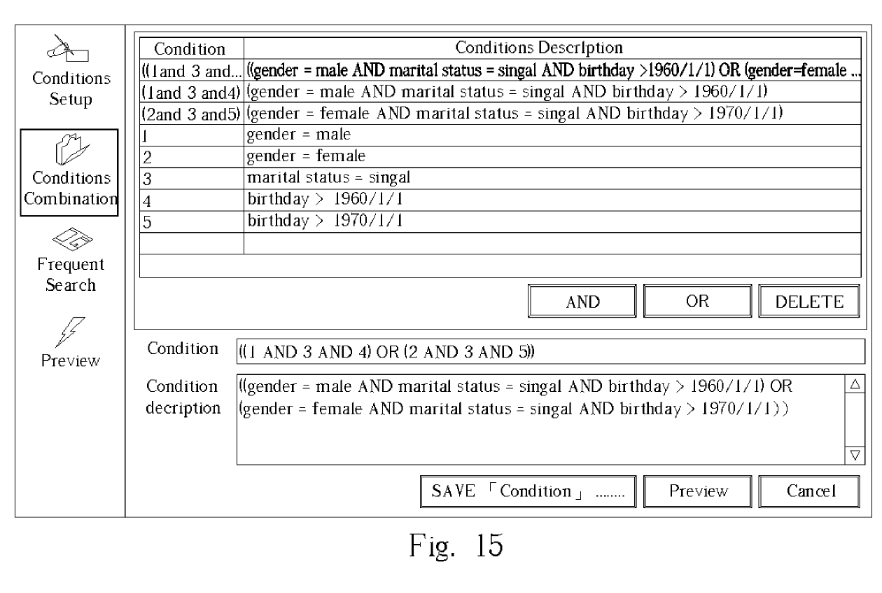

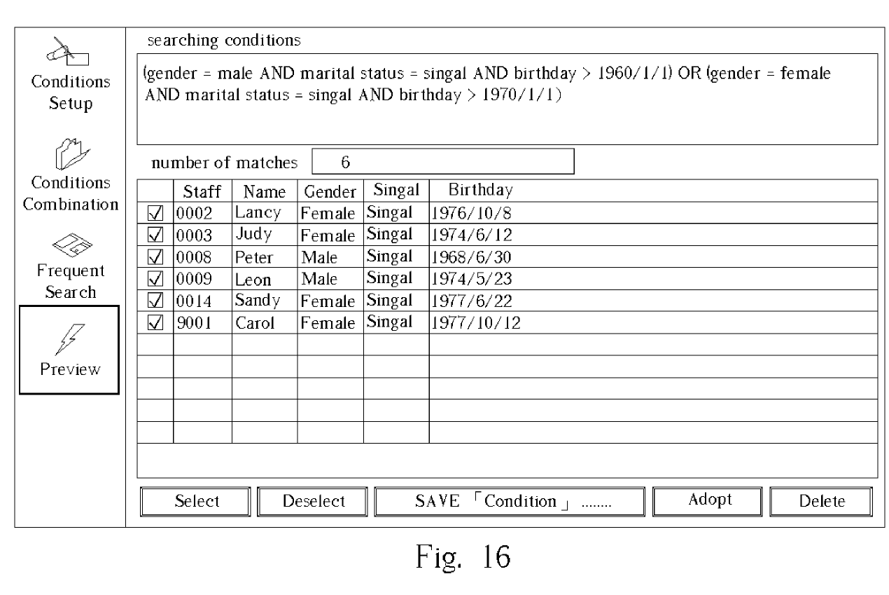

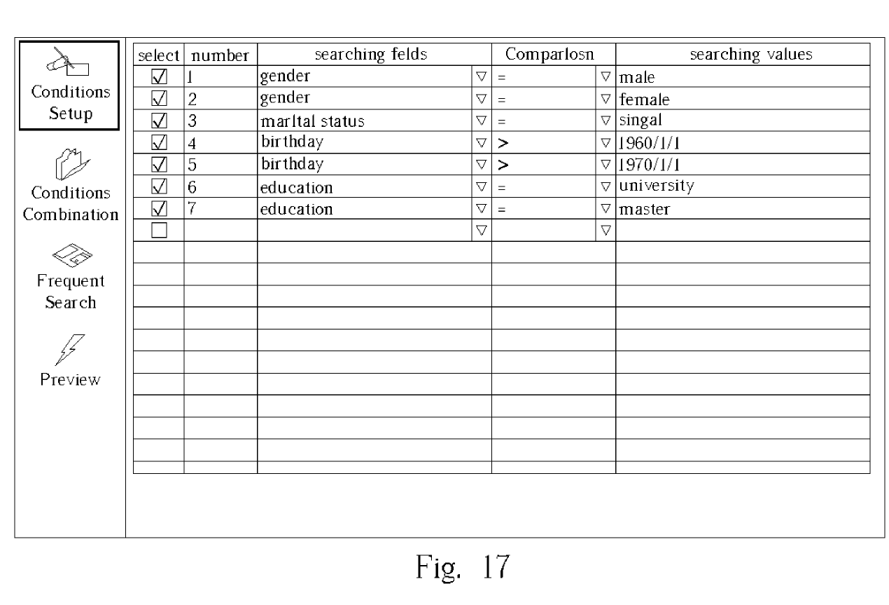

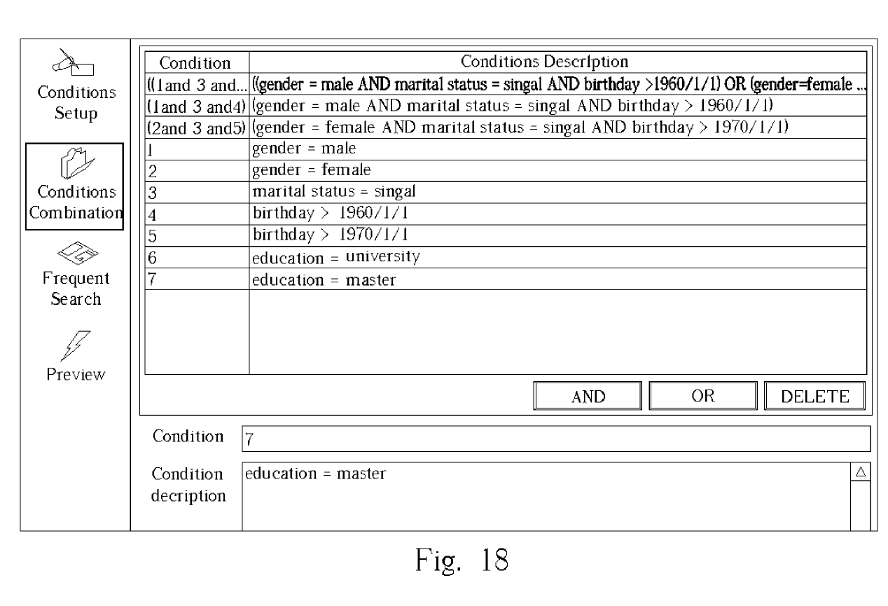

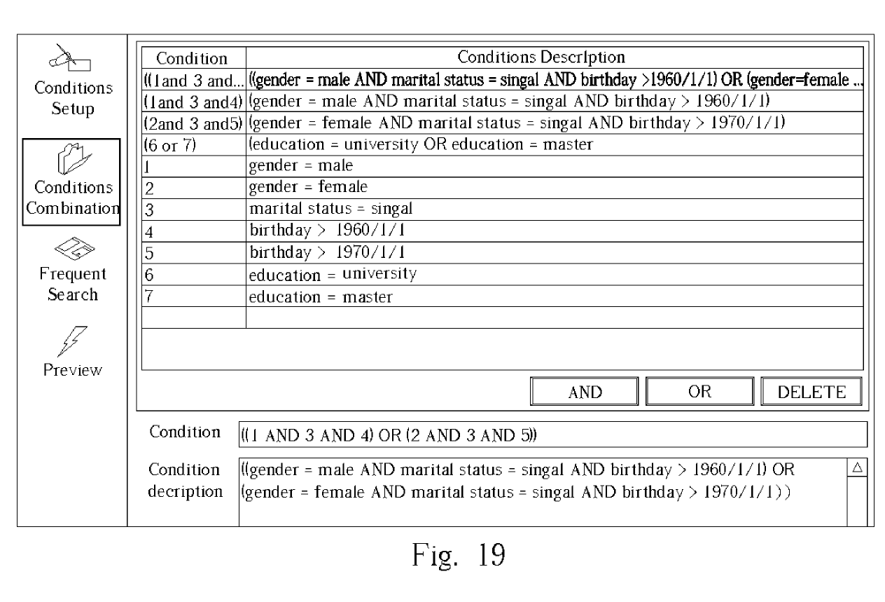

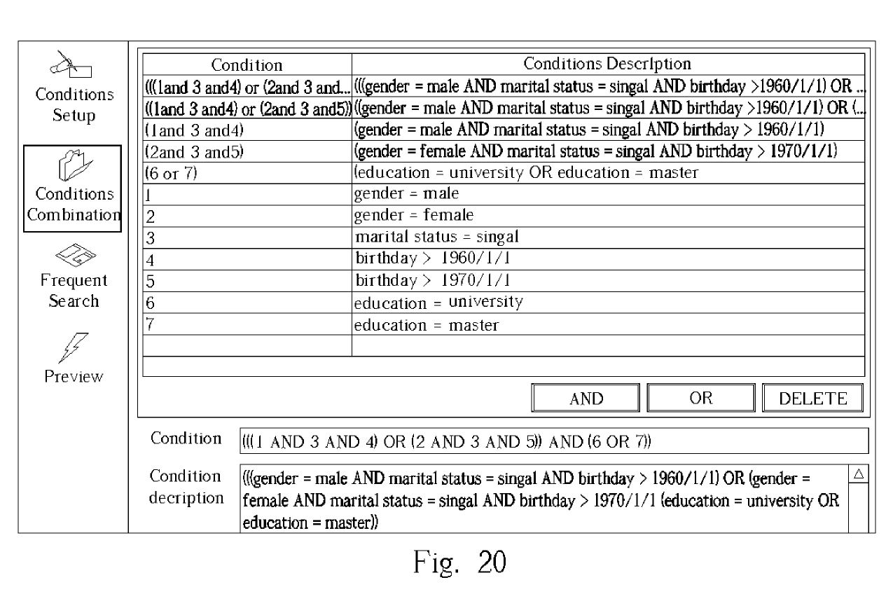

According to the complicated searching condition “((male AND single AND birthday>Jan. 1, 1960) OR (female AND single AND birthday>Jan. 1, 1970) AND (education=university OR education=master)”. The present invention does not need any decomposing action about the searching conditions. Compared to the previous searching condition example, there are two more searching conditions (education=university) and (education=master). As shown in FIG. 17, a user can add two more searching conditions and click the button “combination” to display them. FIG. 18 shows the step of combining the two searching conditions (education=university) and (education=master) with the logic operator “OR”. FIG. 19 shows the step of combing the searching conditions of (education=university OR education=master) and ((male AND single AND birthday>Jan. 1, 1960) OR (female AND single AND birthday>Jan. 1, 1970)) with logic operator “AND”. The system will display the final searching condition “((male AND single AND birthday>Jan. 1, 1960) OR (female AND single AND birthday>Jan. 1, 1970) AND (education=university OR education=master)”, as shown in FIG. 20.

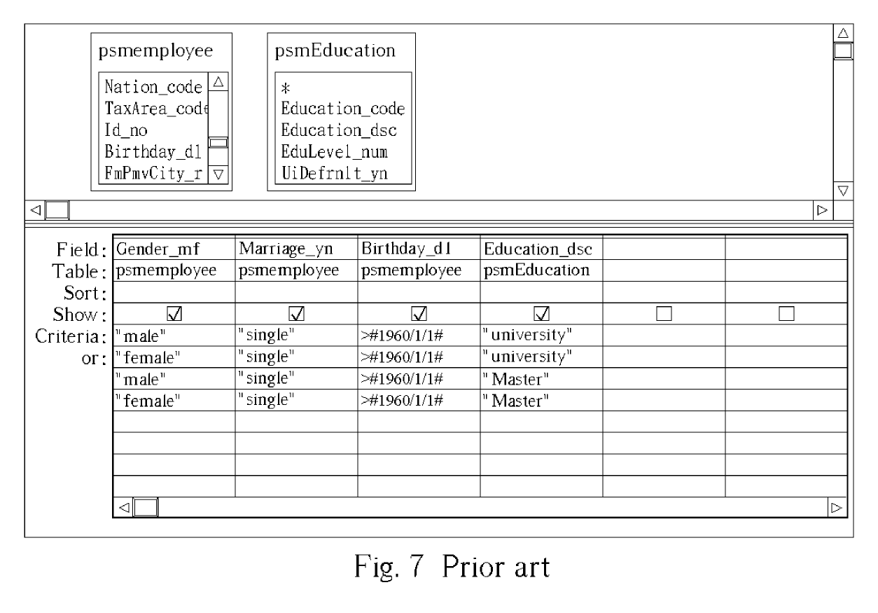

Comparing FIG. 7 in the conventional technology and FIG. 20 of the present invention, the searching condition generated from the present invention more accurately matches the format of the final searching condition. Users need not to analyze or decompose the original searching condition, they only select the combination relation of each searching conditions according to their needs.

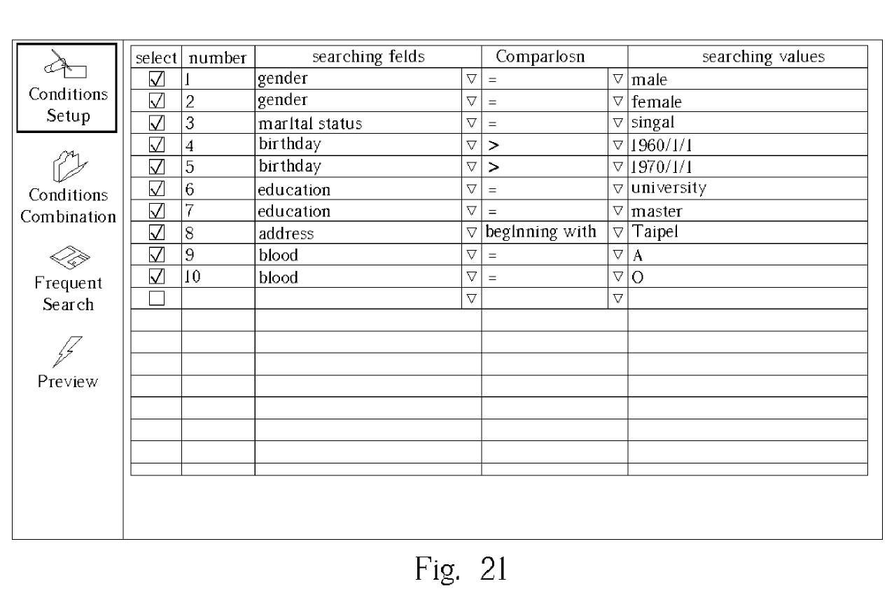

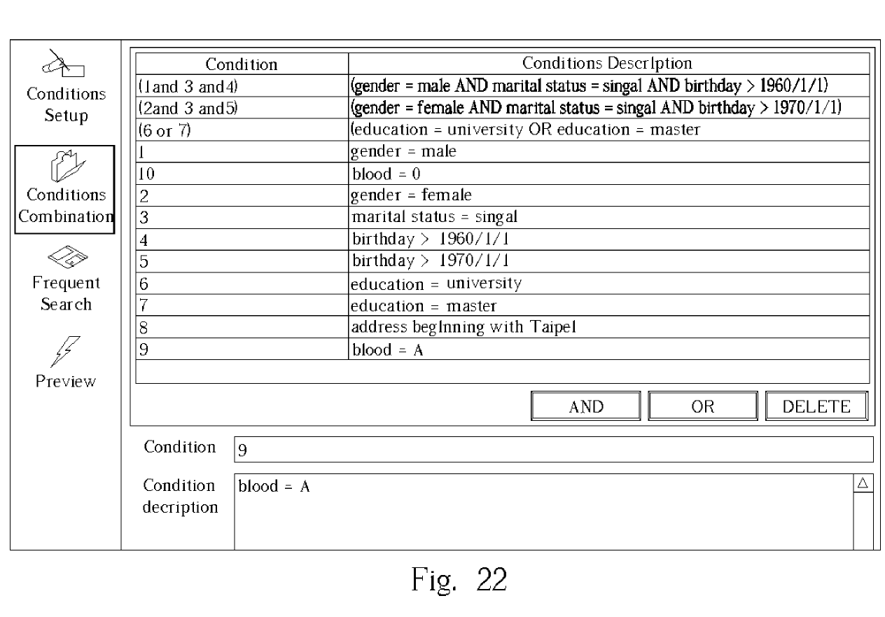

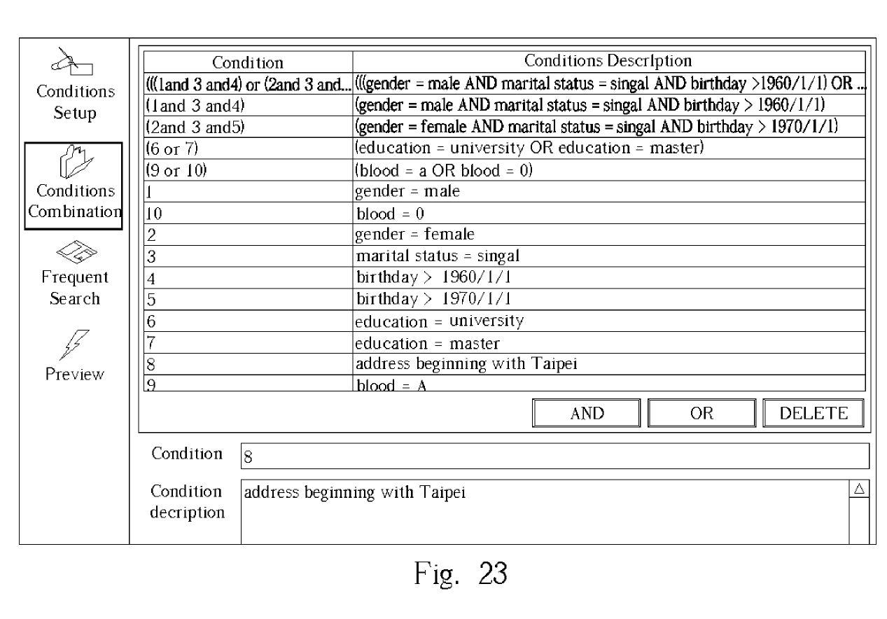

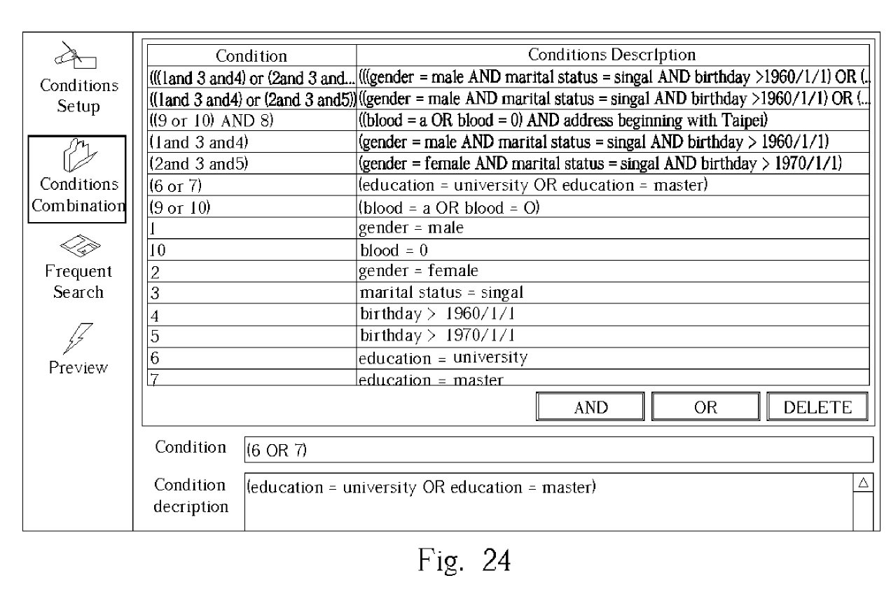

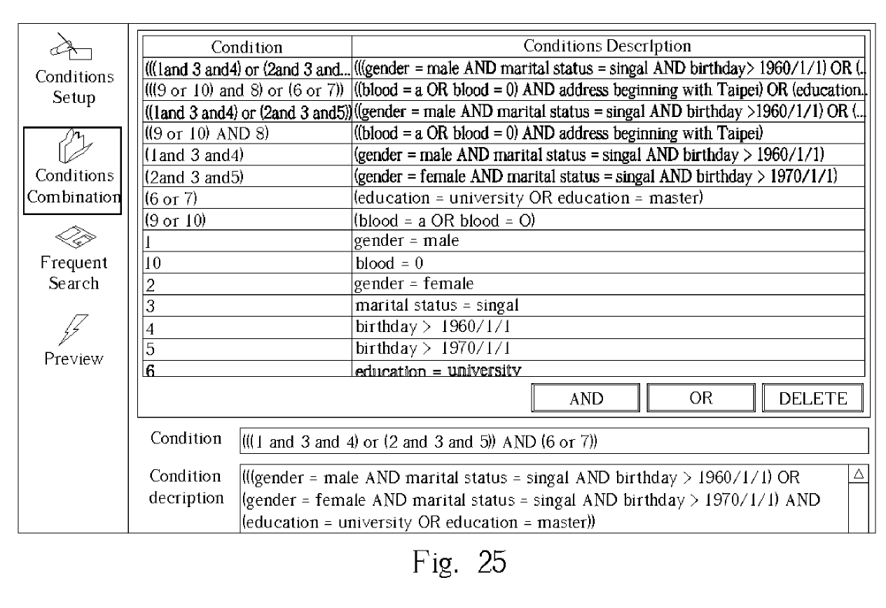

Consider the more complicated searching condition, “((male AND single AND birthday>Jan. 1, 1960) OR (female AND single AND birthday>Jan. 1, 1970) AND ((education=university OR education=master) OR (living in Taipei AND (blood type=O OR blood type=A)))”. Based on the previous example, FIG. 21 shows that a user just needs to add two more searching conditions (“blood type=O” and “blood type=A”) and click the button “Combination” to display them. FIG. 22 shows the step of combing the searching conditions of “blood type=O” and “blood type =A” with the logic operator “OR”. FIG. 23 shows the step of combing the searching conditions of “living in Taipei” and “(blood type=O OR blood type=A)” with logic operator “AND”. FIG. 24 shows the step of combing the searching conditions of “(education=university OR education =master)” and “(living in Taipei AND (blood type=O OR blood type=A))” with logic operator “OR”. FIG. 25 shows the step of combing the searching conditions of “(male AND single AND birthday>Jan. 1, 1960) OR (female AND single AND birthday>Jan. 1, 1970” and “(education =university OR education=master) OR (living in Taipei AND (blood type=O OR blood type=A))” with logic operator “AND”. The user need not first understand the data structure or the corresponding data name. They do not need to decompose the original searching condition either. The system will display the final searching condition “((male AND single AND birthday>Jan. 1, 1960) OR (female AND single AND birthday>Jan. 1, 1970) AND ((education=university OR education=master) OR (living in Taipei AND (blood type=O OR blood type=A)))”, as shown in FIG. 26.

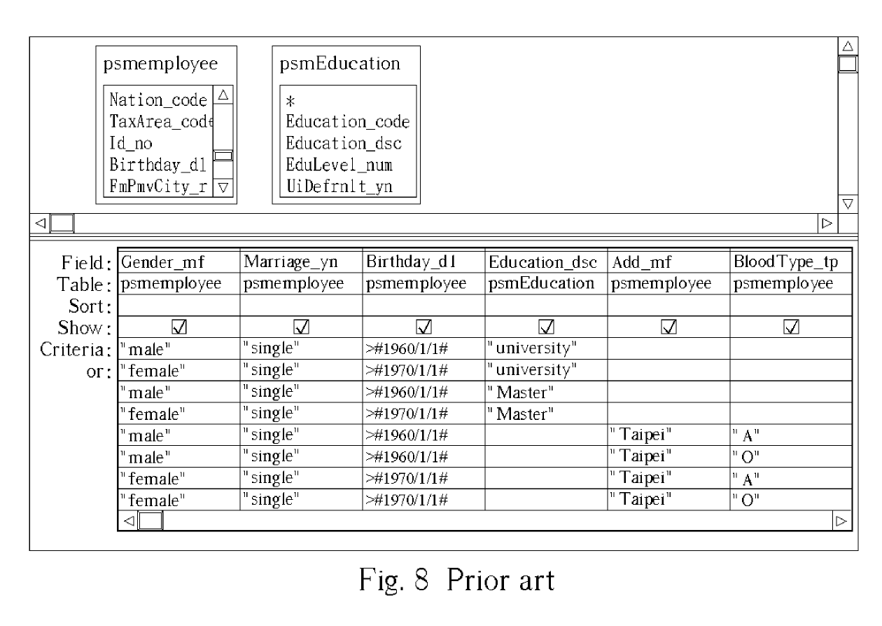

Therefore, Comparing FIG. 8 in the conventional technology and FIG. 26 of the present invention, the present invention is more easy and convenient than the conventional “Searching Table” system. General users can apply it to generate through combination any required searching condition. They do not need to understand or memorize the data structure or data field in the database, and do not need to decompose the searching condition.

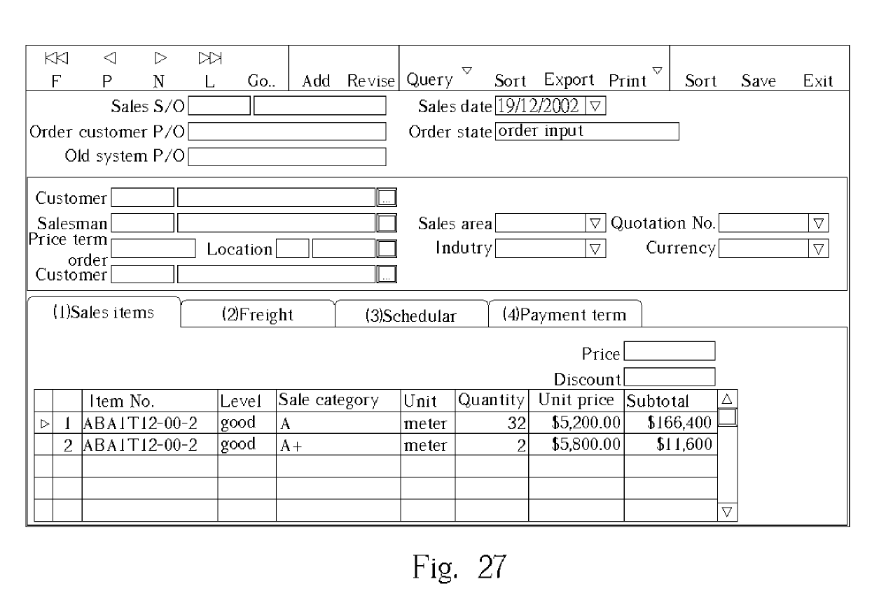

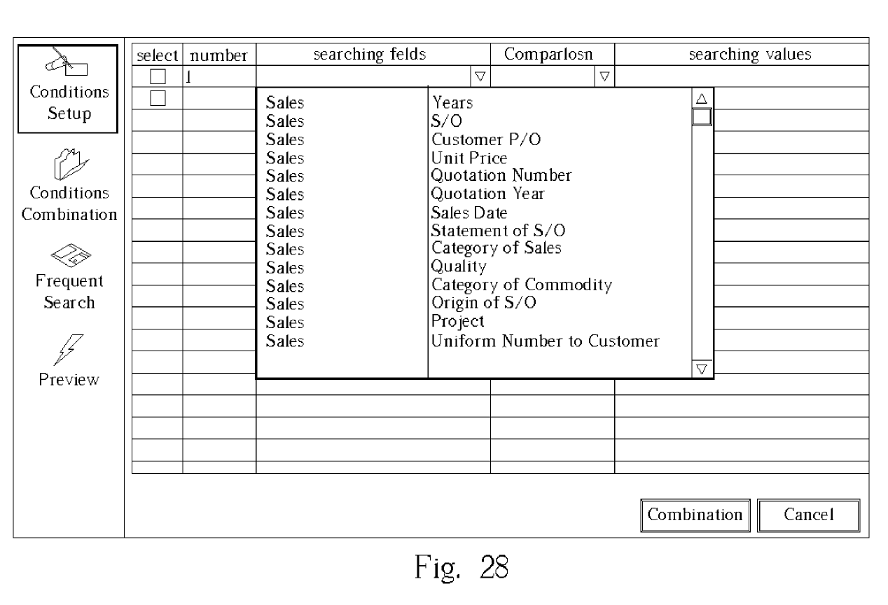

FIG. 27 shows a preferred embodiment of the present invention. On a computerized processing “Sales Order” form executing the search method of the present invention, the search system will display “Search system-Conditions setup” according to the present invention. As showed in FIG. 28, the system will read all the data fields in the tables and son tables related to the “Sales Order” and display all the captions of data fields by drop down menus in each “searching field” for selecting searching subjects.

Comparing the captions of data fields displayed in the “searching fields” with the data fields in the computerized processing form “Sales Order” (FIG. 27), one can see that the data fields displayed in the “searching fields” contain all the data fields in the computerized processing form of “Sales Order” for selecting searching subjects.

It is convenient for users to use this computerized processing form to search for information related to this form. They just need to select directly the captions of data fields in the “searching fields” as searching subjects. Users need not to memorize each caption or data field, the structure, format of the data fields, and the programming language for searching.

The captions of data fields displayed in the “searching fields” are from at least the data fields of the main table in the computerized processing “Sales Order” form. They can also be from the data fields in other pages of forms from son tables. Therefore, the present invention enlarges the range of selecting searching subjects. If there are buttons (or other linking devices) which link other tables and son tables (such as a table of “Accounts Receivable” or “Credit Quota”), the system will read and display them in the “searching fields”, too.

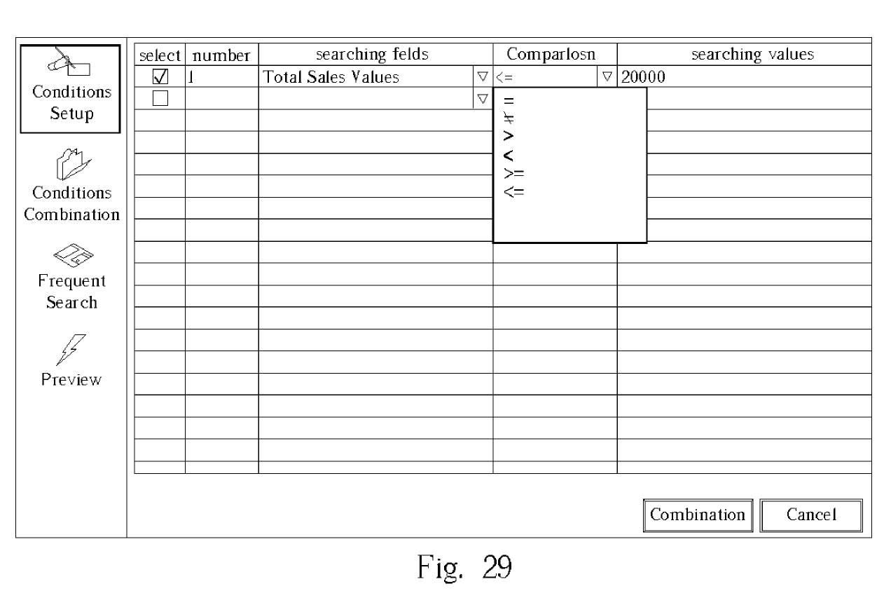

As shown in FIG. 29, if the searching subject selected is “Total sales amount”, the system will determine its data type as “number” and display in the “comparison” field comparison operators such as “=”, “≠”, “>”, “<”, “≧”, and “≦” for selection. In the “searching values” field, the system will automatically limit what is inputted to be fit format of “number”.

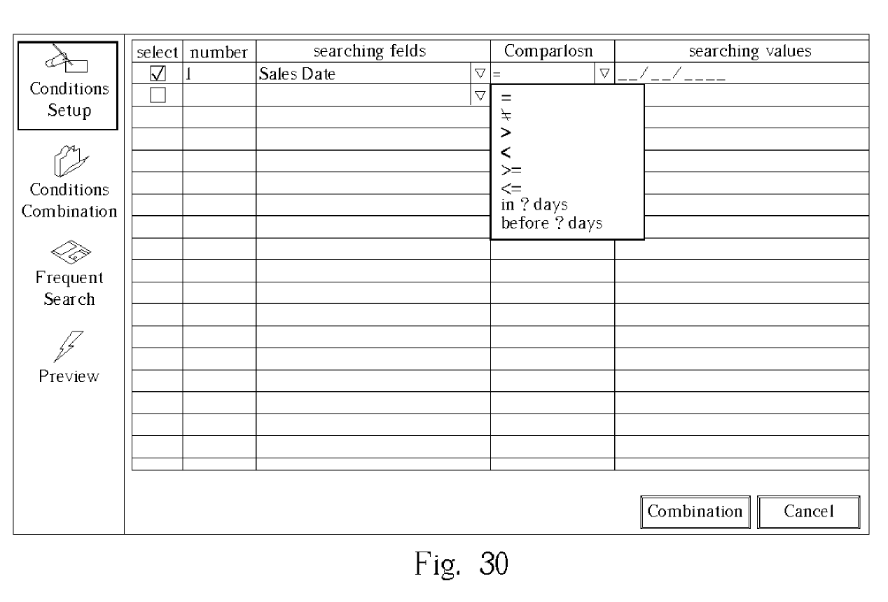

As shown in FIG. 30, if the searching subject selected is “Sales date”, the system will determine its data type as “date” and display in the “comparison” field comparison operators such as “=”, “≠”, “>”, “<”, “≧”, “≦”, “in ? days”, and “before ? days” for selection. In the “searching values“ field, the system will automatically display a date format for input such as “/ /” and limit what is inputted to fit the format of “date” (if the selected comparison operator is “in ? days” or “before ? days”, the system will automatically limit what is inputted to be the format of “number”).

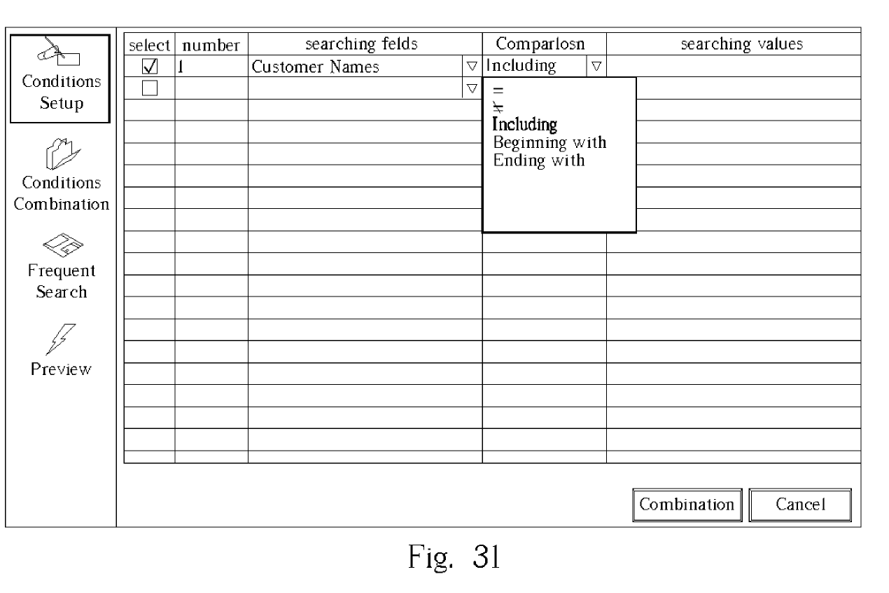

As shown in FIG. 31, if the searching subject selected is “Customer name”, the system will determine its data type as “string” and display in the “comparison” field comparison operators such as “=”, “≠”, “including”, “beginning with”, and “ending with” for selection. In the “searching values” field, the system will automatically limit what is inputted to fit the “string” format.

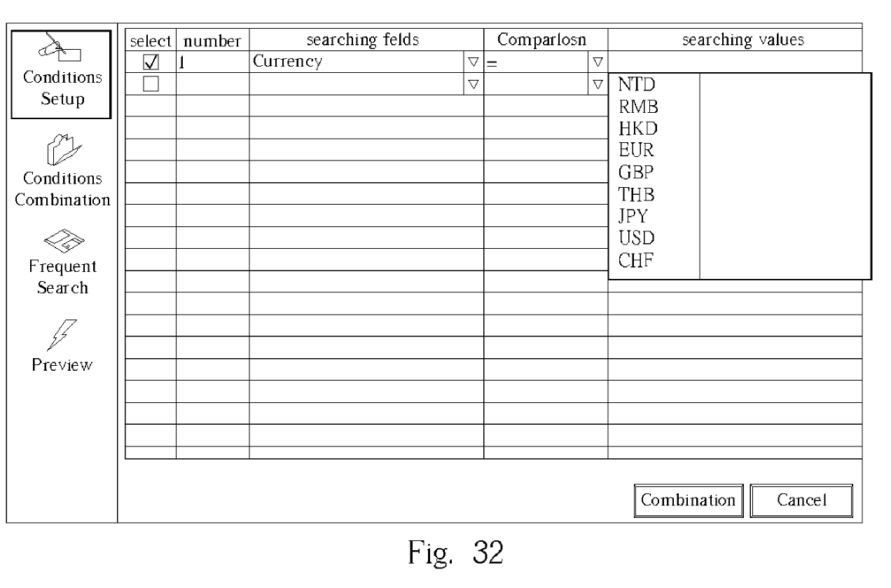

As shown in FIG. 32, if the searching subject selected is “Currency”, the system will determine its data type as “selection list” and display in the “comparison” field comparison operators such as “=” and “≠” for selection. In the “searching values” field, the system will automatically display items such as “US Dollar”, “Euro”, “British Pound”, and “Yen” for selection.

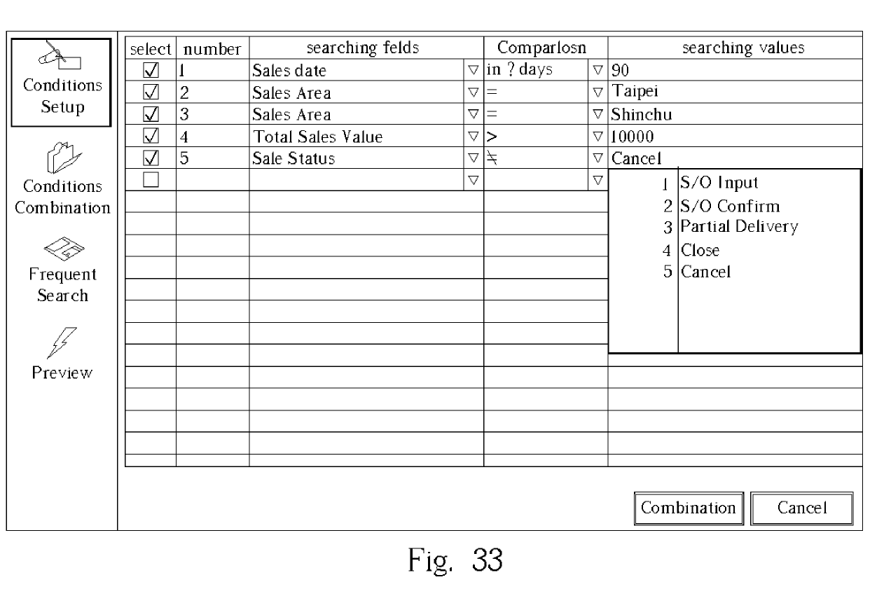

Suppose that a user wants to search for “Sales orders which are not canceled, total sales amount over 10,000, and sales area in Taipei or Shinchu in the last 90 days”. The relative searching condition is “((Sales area=Taipei Or Sales area=Shinchu) And Sales date in 90 days And Total Sales amount>10,000 And Sale status ≠Cancel)” Then, the user can enter the “Search system-Conditions setup” of the present invention and input each single searching condition, as shown in FIG. 33.

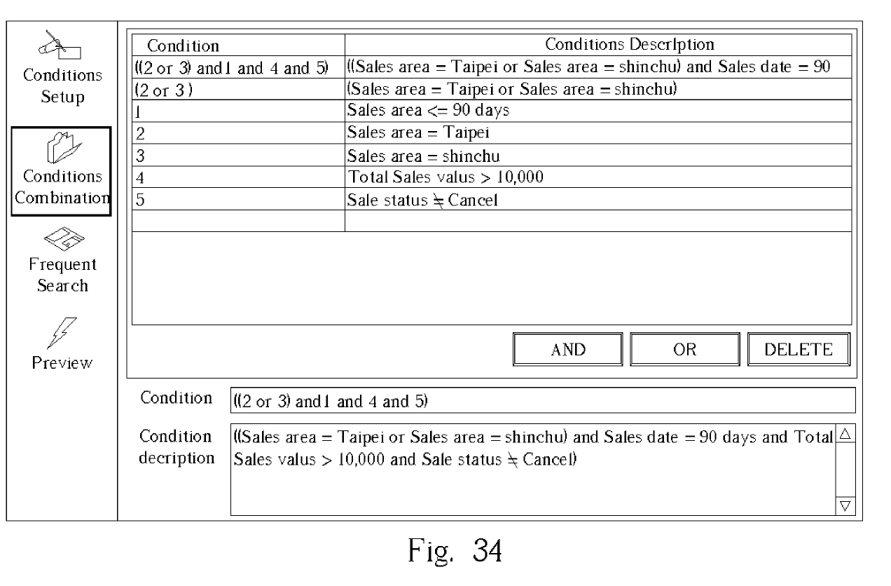

After finishing the setup of single searching conditions, the system will automatically combine and display each searching subject, comparison operator, and searching value to generate each single searching condition in the “Search system Conditions Combination”. FIG. 34 shows that the system automatically combines the selected searching conditions and logic operators to generate and display another composite searching condition “((2 Or 3) And 1 And 4 And 5)”, which is the final desired searching condition.

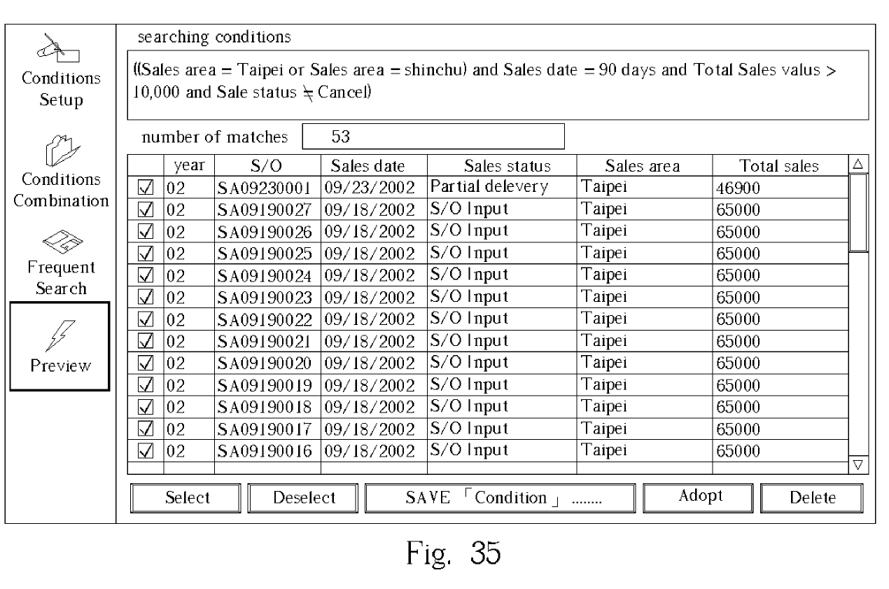

Enabling the user to click the button “Preview”, the system will retrieve information according to the final searching condition. The system will automatically transform the final desired searching conditions to a programming language for searching, retrieve information in the relative database, and display the searching results in the “Search system—Preview”. Shown in FIG. 35 is information retrieved from the final desired searching condition by the search method of the present invention. The “search system—Preview” shows the number of matches “53” and display data values of the searching subjects “Sales date”, “Sales status”, “Sales area”, and “Total sales amount”.

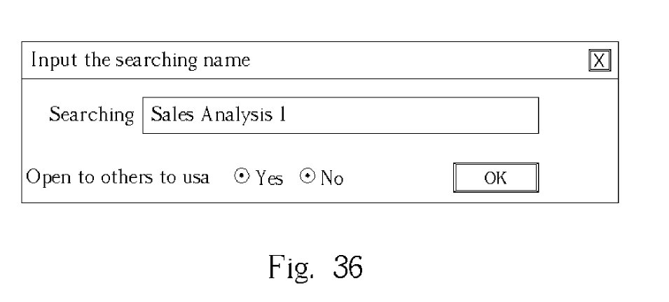

If the user wants to save the searching condition, he or she can click the “Save” button. As shown in FIG. 36, the system will display a form for inputting a saving name, and allow the user to input the saving name and click “OK”. The system will save the searching condition in the database for a subsequent similar or identical search. It will synchronically save the user name that sets the searching conditions, and the user can choose whether the searching condition is open for public use (public can mean all users, or a subgroup such as a workgroup or department).

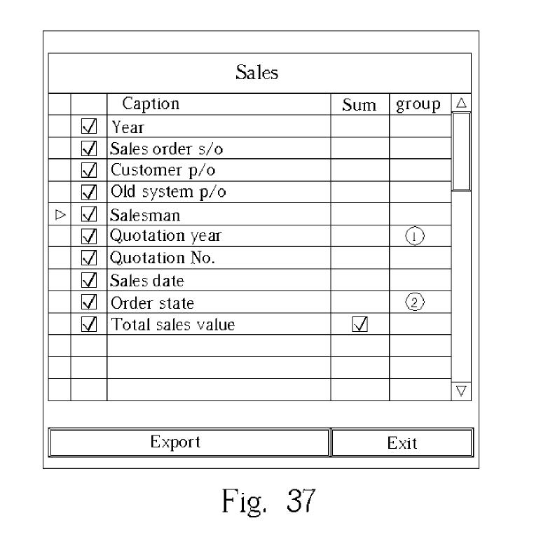

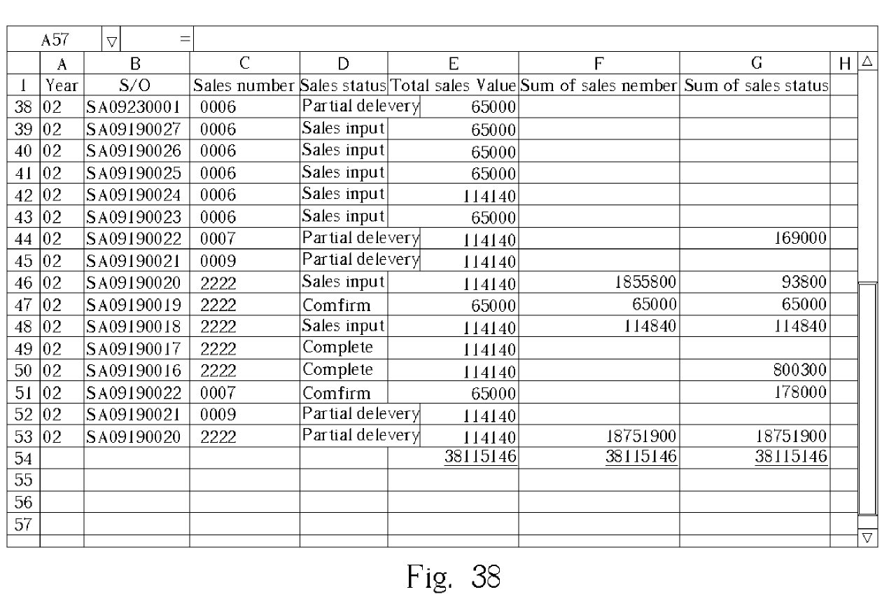

When the user clicks the button “Adopt”, the system will display all detailed information matching the searching condition. Moreover, the search method of the present invention provides the function of exporting the retrieved information to other files for advanced management or analysis. As shown in FIG. 37, the system will display all the captions of data fields in the computerized processing “Sale Order” form, enabling the user to select the data fields to be exported. The function of exporting retrieved data can further group the retrieved information according to the choices that the user prefers. Moreover, if the data are countable, the system can sum each sub-group and total amount. Shown in FIG. 38 is the computerized screen of exporting retrieved information into an EXCEL file.

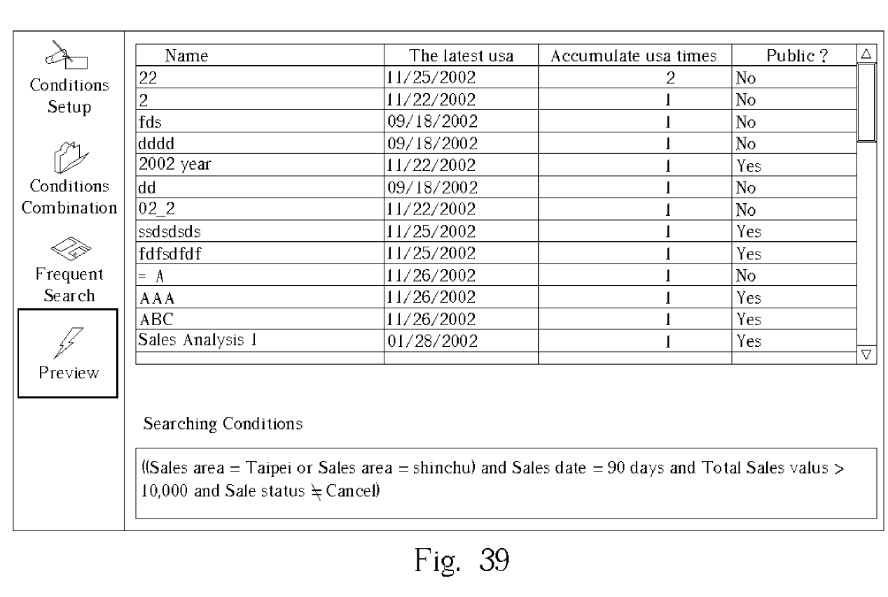

The function of saving searching conditions provided by the present invention allows users to avoid repeatedly setting up frequently used conditions. Moreover, users can directly use the saved searching conditions to retrieve updated information. When the user logs in again to execute the function of “Search system frequent search” of the present search system, as shown in FIG. 39, the system will select and display the names of all searching conditions that this user has saved in addition to public searching conditions. If a searching condition is public, then any user can use the searching condition to do search work. This function can accelerate personalized search demands.

If any saved searching conditions are to be deleted, the user can select the searching conditions and click the “Delete” button. On clicking the “Preview“ button, the system will display all detailed information matched to the searching condition in the present computerized processing form calling the search system. It also provides the function of exporting the retrieved data to other files such as EXCEL.

According to the description of the preferred embodiments above, the present invention allows users who have no knowledge about database systems to perform composite search work to quickly find precise search information.

The search method of the present invention can be applied in different computerized processing forms. The system can read each forms data field captions for convenience in selection and combination. The search interface of the conventional search system limits users to only search with a few constant fields, the logic conditions between search fields having been fixed. The present invention is far more flexible and user-friendly. Multiple prior art search interfaces still cannot generate the search conditions that can be generated from the combinations of the data fields in the computerized processing form of the present invention.

In the search method of the present invention, the system will automatically read different data fields for users to select and combine. The degree of user friendliness and flexibility is thus improved substantially. Users can spend less time searching and make fewer iterations to obtain the final desired information. The present invention improves the accuracy and efficiency of a search system and provides unlimited field search combination.

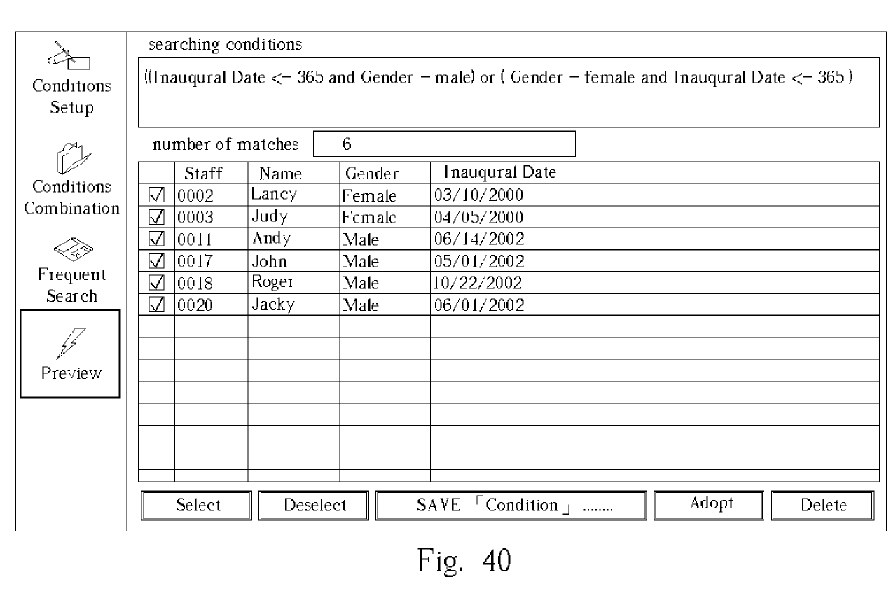

Referring to FIG. 40, how the present invention can find information in fewer user iterations is explained. In the employee form in the human resource management system, if the final desired search condition is 37 females who have worked for over one year OR males who have worked for less one year”. The conventional search system will need to retrieve employees whose “start working dates before 365 days AND gender=female”. Then the conventional search system will need to retrieve employees whose “start working date in 365 days AND gender=male”. After that, users need to combine the two search results together by themselves. In contrast, the present invention provides a method to combine those searching conditions together to generate a final desired searching condition. Therefore, users need only perform a single search. Compared to the conventional search system requiring two searches to get the final results, the present invention saves a lot of manual search work and searching time.

Providing more precise information and increasing user satisfaction are goals that a good search system should strive towards. The necessary condition to reach these goals is diversification in a search system, diversifying the data fields and searching conditions. Because the conventional search systems cannot match the individual requests of various data fields and searching conditions, the present invention is dedicated to diversification in a search system. The present invention not only improves the deficiencies of the conventional search system, but also contains unique and innovative structures. We described these special advantages of the present invention as follows:

1. Non-technical users also can apply the present invention to perform thorough information searches. When inputting the searching conditions, users can make selections by combo boxes or drop down menus (via an electronic form that displays the options). This friendly interface can help to quicken searching conditions set up and reduce the mistakes made by manual typing. Users need not memorize the corresponding codes of the captions of data fields. Users also need not understand the structures of databases and their interrelations and need not decompose the original searching request. Users can directly use the search method of the present invention to select captions of desired data fields to search to generate the desired searching conditions.

2. The present invention realizes the goal of diversifying “data fields”. Because the conventional search systems provide only fixed or restrictive searching subjects (data fields), users cannot choose the searching subjects to match their specific requests. To improve this drawback, the present invention provides unrestrictive data fields for users to select according to the final desired searching condition to allow more precise search work.

3. The present invention realizes the goal of diversifying “searching conditions”. The conventional search systems provide only limited logic operators to support the searching conditions set up. A few systems provide some logic operators, but they restrict the priority to execute the searching combinations of different or identical data fields, “AND”, “OR”, and “NOT” in sequence. This method cannot reach the goal of the diversification of “searching conditions”. The diversification of “searching conditions” means that users can search by combining the different searching conditions in an arbitrary logical permutation to generate the final desired searching condition. To reach this goal, the present invention provides the logical operator “( )38 added to the searching conditions that are to be searched in priority. In other words, the searching conditions can be combined freely. This is one of the characteristics of the present invention.

4. Another important innovation of the present invention is that it provides an unlimited number of searching subjects to generate a final desired search condition via only one instance of information retrieval. Moreover, the present invention provides appropriate comparison operators to choose according to different types of the data fields. Users can understand the subjects type more conveniently. According to the searching conditions of different or identical data fields, the present invention not only provides complete logic operators (“AND”, “OR”, etc.) but also provides the logic operator “( )” for combining different searching conditions in order to reach the goal of providing more appropriate and precise searching directions at the same time, increasing the satisfaction in search results.

5. In the aspect of setting up the searching conditions, the present invention provides different comparison operators according to different types of the searching subjects (data fields). If the data type is number or date, the present invention provides comparison operators such as “≠”, “=”, “>”, “<”, “>”, “<==”. It provides other comparison operators “before ? days” and “in ? days” for the “date” data type. If the data type is string, the present invention provides comparison operators such as “≠”, “=”, “including”, “beginning with”, and “ending with”. If the data type is Boolean (yes or no) or “selection type”, the present invention provides comparison operators such as “≠” and “=”.

6. The present invention provides complete logical operation combinations. There are no restrictions on data fields or the frequency of combining the searching conditions. Users can set up the precise searching conditions they need. The present invention provides a highly flexible and convenient search system.

7. The present invention can record or save the searching conditions for following uses, so that users need not set up the same searching conditions again. This increases the efficiency of operating the present invention search system. Additionally, the present invention can export the searching results by choosing the data fields to be exported and grouping and summing the searching results to export to another file format. This allows the user to perform other analysis or operations on the search results.

8. The search method of the present invention has the same structure of search interface, and the system will automatically read different data fields for users to select and combine. The degree of user friendliness and flexibility is improved substantially, and users can search the final desired information in less time and with fewer search iterations. The search method of the present invention improves the accuracy and efficiency, and provides an unlimited field search.

Those skilled in the art will readily observe that numerous modifications and alterations of the device may be made while retaining the teachings of the invention. Accordingly, the above disclosure should be construed as limited only by the metes and bounds of the appended claims.

1. A method for setting searching conditions, comprising the steps of:
(i.) reading a data type, name, caption, table, and database of data fields contained in a computerized processing form and displaying captions of data fields in a user interface;
(ii.) accepting at least two groups of: a searching subject corresponding to a data field, a comparison operator, and a searching value;
(iii.) combining the searching subject, comparison operator, and searching value of each group to generate at least two single searching conditions, and displaying the two single searching conditions;
(iv.) receiving a selection of at least two displayed single searching conditions, receiving a selected logic operator, combining the selected single searching conditions and the logic operator to generate a composite searching condition, and displaying the composite searching condition;
(v.) if the composite searching condition is not equal to a final desired searching condition, receiving a selection of at least two of: the single searching conditions or the composite searching condition, receiving a second selected logic operator, and generating and displaying a new composite searching condition; and
(vi.) repeating step (v.) until any generated composite searching condition equals the final desired searching condition.

2. The method of claim 1 wherein said data fields contained in the computerized processing form are from data fields of related tables in the database.

3. The method of claim 1 wherein step (v.) further comprises accepting a new group of searching subject, comparison operator, and searching value; and generating and displaying a new single searching condition for selection.

4. The method of claim 1 wherein reading the data type, name, caption, table, and database of data fields contained in the computerized processing form further comprises reading the data type of the selected searching subject and displaying appropriate comparison operators for the data type, wherein:
if the data type is string, displaying comparison operators including at least “=”, “≠”, “including”, “beginning with”, and “ending with”;
if the data type is number, displaying comparison operators including at least “=”, “≠”, “>”, “<”, “ [symbol] ”, and“ [symbol] ”;
if the data type is date, displaying comparison operators including at least “=”, “≠”, “>”, “<”, “ [symbol] “, “ [symbol] ”, “before ? days”, and “in ? days”; and
if the data type is Boolean or selection list, displaying comparison operators including at least “=” and “≠”.

5. The method of claim 1 wherein reading the data type, name, caption, table, and database of data fields contained in the computerized processing form further comprises reading the data type of the selected searching subject and displaying and controlling the data type of the searching value, wherein:
if the selected searching subject data type is string, displaying a space for inputting the searching value and controlling input to be a string data type;
if the selected searching subject data type is number or date and the selected comparison operator is “before ? days” or “in ? days”, displaying a space for inputting the searching value and controlling input to be a number data type;
if the selected searching subject data type is date and the selected comparison operator is “=”, “≠”, “>”, “<”, “ [symbol] ”, or “ [symbol] ”, displaying a space for inputting the searching value and controlling input to be a date data type;
if the selected searching subject data type is Boolean, displaying selection items “YES” and “NO” for inputting the searching value; and
if the selected searching subject data type is selection list, displaying selection items of the selected searching subject for inputting the searching value.

6. The method of claim 1 wherein when generating a composite searching condition or a new composite searching condition, forming a hierarchy of the single search conditions and any composite searching condition.

7. The method of claim 1 wherein step (iv.) further comprises receiving a delete command, and subsequently deleting a displayed searching condition identified by the delete command.

8. The method of claim 1 wherein step (vi.) further comprises displaying retrieved results of a selected searching condition comprising:
accepting the selected searching condition;
accepting a displaying command; and
retrieving and displaying all data matching the selected searching condition.

9. The method of claim 8, further comprising exporting the searching results to another file format comprising:
displaying captions of data fields for selection of data fields to be exported;
receiving selections of data fields and layers of grouping;
accepting an exporting command, and calculating a sum of countable data according to a layer of grouping of data fields; and
exporting the searching results by grouping and the sum to the other file format.

10. The method of claim 1 wherein step (vi.) further comprises saving a selected searching condition comprising:
accepting the selected searching condition;
accepting a save command;
accepting input of a file name for the searching condition; and
saving the searching condition and its file name in a computer storage device.

11. The method of claim 10, further comprising recording a user identification of the user who saved the searching condition and whether the saved searching condition is for private or public use.

12. The method of claim 1, further comprising using a saved searching condition comprising:
accepting a load command;
displaying file names of saved searching conditions;
accepting a selected searching condition and a displaying command; and
retrieving and displaying all listed data matching the selected searching condition.

13. The method of claim 12, further comprising deleting a saved searching condition comprising receiving a delete command, and subsequently deleting a selected saved searching condition identified by the delete command.

14. A method for setting searching conditions comprising:
reading a data type, name, caption, table, or database of data fields contained in a computerized processing form, wherein said data fields are from data fields of at least a related table in the database, and displaying captions of data fields in a user interface;
providing an input form for searching subject, comparison operator, and searching value; displaying and controlling input of a searching value according to a data type of the corresponding searching subject, and displaying comparison operators corresponding to the data type of the searching subject;
separately combining at least two groups of inputted searching subject, comparison operator, and searching value to generate at least two single searching conditions, and displaying the two single searching conditions;
combining at least two selected single searching conditions and a selected logic operator to generate a composite searching condition, and displaying the composite searching condition;
if any composite searching condition is not equal to a final desired searching condition, combining at least two of: the single searching conditions or the composite searching condition, according to a second selected logic operator, thereby generating and displaying a new composite searching condition; and
repeating the previous step until a composite searching condition equals the final desired searching condition.

15. The method of claim 14 further comprising retrieving and displaying results of a selected single or composite searching condition in the user interface.

16. The method of claim 14 further comprising combining a new group of inputted searching subject, comparison operator, and searching value to generate a new single searching condition, and displaying the new single searching condition.

17. The method of claim 16 further comprising retrieving and displaying results of a selected single or composite searching condition in the user interface.

18. The method of claim 14 further comprising providing an input form for saving, deleting, exporting, or displaying at least a single or composite searching condition.

19. A method for setting searching conditions comprising:
a step for reading a data type, name, caption, table, or database of data fields contained in a computerized processing form;
providing an input means for receiving searching subject, comparison operator, and searching value;
a step for controlling input of searching value and comparison operator according to searching subject;
a step for combining at least two groups of inputted searching subject, comparison operator, and searching value to generate at least two single searching conditions;
a step for combining at least two selected single searching conditions and a selected logic operator to generate a composite searching condition; and
determining whether the generated composite searching condition equals a final desired searching condition, and repeating the previous step until a generated composite searching condition equals the final desired searching condition.

20. The method of claim 19 further comprising a step for combining single or composite searching conditions for generating a composite searching condition.

21. The method of claim 19 further comprising:
providing a means for selecting a single or composite search condition; and
providing a means for displaying at least a single or composite searching condition.

22. The method of claim 21 further comprising:
providing a means for saving at least a single or composite searching condition, wherein access to the saved searching condition is restricted to a predetermined group;
providing a means for deleting at least a single or composite searching condition; and
providing a means for exporting at least a single or composite searching condition.
